(19) United States
(12) Patent Application Publication
(10) Pub. No.: US 2022/0005039 A1
(43) Pub. Date: Jan. 6, 2022

(54) DELEGATION METHOD AND DELEGATION REQUEST MANAGING METHOD

(71) Applicant: Richard Philip Hires, Windsor, CT (US)

(72) Inventor: Richard Philip Hires, Windsor, CT (US)

(21) Appl. No.: 17/318,654

(22) Filed: May 12, 2021

Related U.S. Application Data
(60) Provisional application No. 63/047,693, filed on Jul. 2, 2020.

(51) Int. Cl. G06Q 20/40; G06Q 20/36; G06Q 20/38; G06Q 20/06

(52) U.S. Cl. CPC G06Q 20/4014; G06Q 20/06; G06Q 20/3821; G06Q 20/3674

(57) ABSTRACT

A computer-implemented method for managing a delegation request is provided. The method includes linking a first account of a first user with a second account of the first user and receiving the delegation request from the first user, to delegate an access for the second account of the first user to a second user. The method further includes extracting, from the received delegation request, a delegation request payload and verifying the delegation request based on the extracted delegation request payload. Furthermore, the method includes transmitting the verified delegation request to an identity verification database, receiving, from the identity verification database, an authentication response indicating authentication of the first user, the second user and the delegation of access for the second account of the first user to the second user, and allocating, to the second user, an authority to conduct a transaction for the second account based on the authentication response.

### CROSS-REFERENCE TO RELATED APPLICATIONS

This application claims priority from U.S. Provisional Application No. 63/047,692 filed on Jul. 2, 2020 and entitled “Digital Delegation Enabled by a Mobile Identity Platform” the entire contents of which are hereby fully incorporated herein.

### TECHNOLOGICAL FIELD

The present disclosure generally relates to digital identity management systems, and more particularly relates to delegation request management related to digital identity management systems.

### BACKGROUND

Currently, there are various delegation methods for assigning an authority from one individual to another individual to perform an activity using digital platforms. For instance, the currently available delegation methods allow an individual to authorize a relying party to take decisions for conducting a digital transaction on-behalf of the individual. These available delegation methods heavily rely on manual relationship verifications predicated on a possession of physical documents or devices and/or an individual's knowledge of a shared secret such as a password, other credentials, etc. However, in many cases, the available delegation methods are vulnerable to fraud and abuse. Further, the available delegation methods lack in possessing a verifiable proof of an actual initiator of the activity, as the available delegation methods merely rely on the manual relationship verifications. Thereby, the available delegation methods are not able to provide non-repudiation guarantee for conducting the digital transaction on the basis of the delegation. For instance, the individual (owner of a resource) can claim no knowledge or authorization of an activity that a delegate performed using one of the individual's digital accounts, even though the individual may have provided a verbal, manual or digital permission to the delegate for conducting the activity. The individual can directly blame the delegate, and vice versa, because of lack of non-repudiation guarantee in existing methods of delegation.

Accordingly, there is a need for providing some form of non-repudiation guarantee to perform the activity such that the vulnerabilities like fraud and abuse in digital transactions are avoided and the non-repudiation aspect is addressed appropriately.

### BRIEF SUMMARY

In order to solve the foregoing problem, the present disclosure provides a system to implement the delegation method for allocating, from a first user to a second user, an authority to perform an activity on-behalf of the first user, while the vulnerabilities like fraud and abuse are avoided and the non-repudiation aspect is addressed. As used herein, the activity includes access to protected data, a digital transaction and the like. The digital transaction includes a financial transaction, a medicine purchase, and the like. In some embodiments, the activity is associated with at least one transaction account of the first user. The user may have multiple accounts, like a first account, a second account and the like. The user may want to delegate an authority for conducting a transaction using, for instance, the second account. To that end, the system allocates the authority of the second account of the first user to the second user for performing the activity. In some embodiments, the system allocates the authority of the second account to the second user, using the first account of the first user and a fourth account of the second user. To that end, the system allows the first user and the second user to create the first account and the fourth account respectively. The first account of the first user and the fourth account of the second user are associated with the system. As used herein, the first account of the first user is an identity account of the first user and the fourth account of the second user is an identity account of the second user.

Once the identity accounts associated with the system are created, the system allows the user (e.g. the first user and/or the second user) to link their corresponding identity account with at least one transaction account. For instance, the system allows the first user to link the first account of the first user with the second account of the first user. For linking the first account with the second account, the first user sends, from the second account of the first user to the system, an account link request. In other words, the system receives the account link request from the second account of the first user. Upon receiving the account link request, the system identifies the first account. The system authenticates the first user using the first account of the first user by transmitting, to the first account of the first user, an account linking authentication request and by receiving an account linking authentication response from the first account of the first user. The first account of the first user is associated with an identity verification database to enable receiving of the account linking authentication request and transmitting account linking authentication response. The account linking authentication response indicates a result of authentication. If the account linking authentication response is positive, the system links the first account of the first user with the second account of the first user.

Once the first account of the first user is linked with the second account of the first user, the system allows the first user to allocate the authority of the second account to the second user using the first account of the first user and the fourth account of the second user. For allocating the authority of the second account to the second user, the first user sends, to a relying party application database associated with the second account of the first user, a delegation request. Upon receiving the delegation request, the relying party application database extracts a delegation request payload from the delegation request. Further, the relying party application database verifies the delegation request by verifying, using the extracted delegation payload, the ownership of the second account and by verifying, using the extracted delegation payload, identity associated with each of the first account of the first user and a third account of the second user. The third account of the second user is associated with the relying party application database.

Once the delegation request is verified, the relying party application database generates encrypted delegation request data, for instance, a first encrypted data associated with the first account, a second encrypted associated with the fourth account, and a third encrypted data associated with the second account. The third encrypted data may be further used by the relying party application database in subsequent operations to verify whether the authority of the second account of the first user is allocated to the second user. Further, the relying party application database transmits, to the system, the first encrypted data, the second encrypted data, and the third encrypted data. In other words, the system receives the first encrypted data, the second encrypted data, and the third encrypted data. The system authenticates the first user using their first account, based on the first encrypted data. For this, the system transmits a first authentication request to the first account of the first user and receives a first authentication response from the first account of the first user. The first authentication response indicates the result of authentication. If the first authentication response is positive, the system authenticates the first user. The system further authenticates the second user, using the fourth account of the second user, based on the second encrypted data. For this, the system transmits a second authentication request to the fourth account of the second user and receives a second authentication response from the fourth account of the second user. The second authentication response indicates the result of authentication. In some embodiments, if the second authentication response is positive, the system allocates the authority of the second account of the first user to the second user. In some other embodiments, if the second authentication response is positive, the system sends, to the relying party application database, an authentication response comprising the first authentication response indicating the authentication of the identity of the first user, the second authentication response indicating the authentication of the identity of the second user, and confirmation data indicating confirmation for delegating of the authority to the second user for accessing the second account. Upon receiving the authentication response, the relying party application database allocates the authority of the second account of the first user to the second user.

Once the authority of the second account is allocated to the second user, the system allows the second user to perform the activity using the second account. For instance, when the second user logins into a relying party application associated with the relying party application database, the relying party application database may receive a login request. Upon receiving the login request, the relying party application database may generate and transmit, to the system, an authorization payload request. In other words, the system receives the authorization payload request. Upon receiving the authorization payload request, the system authenticates the second user using the fourth account of the second user by transmitting a login authentication request to the fourth account of the second user and by receiving a login authentication response from the fourth account of the second user. The login authentication response indicates the result of authentication. If the login authentication response is positive, the system performs a lookup search for identifying the third encrypted data. Further, the system communicates, to the relying party application database, the third encrypted data as authorization data. The relying party application database in-turn communicates the authorization data associated with the second user to the second user. The authorization data includes a message indicative of allocation of the authorities of the second account of the first user to the second user.

Once the authorization data is communicated to the second user, the second user may try to perform the activity using the second account. When the second user tries to perform the activity using the second account, an activity request for the second account of the first user from the second user is sent to the relying party application database. The relying party application database in-turn forwards the activity request to the system for confirming authorization. To that end, the system receives the activity request for the second account of the first user from the second user via the relying party application database. Upon receiving the activity request, the system authenticates, using the fourth account of the second user, the second user by transmitting an activity authentication request to the fourth account of the second user and by receiving an activity authentication response from the fourth account of the second user. The activity authentication response indicates the result of authentication. If the activity authentication response is positive, the system processes the activity request by transmitting, to the relying party application database, an activity confirmation response for performing the activity. Upon receiving the activity confirmation response, the relying party application database conducts the activity (transaction) for the second account of the first user.

Further, the system allows the first user to revoke the authority of the second account from the second user, when the first user wants to the revoke the authority of the second account from the second user. Furthermore, the system allows the first user, the second user, and the relying party application database to request the first encrypted data, the second encrypted data, and the third encrypted data respectively to reference the authority related information, such as what permissions are granted to the second user for various types of transactions associated with the second account.

In this way, the system provided herein allocates, from the first user to the second user, the authority (to conduct a transaction and/or activity) associated with the second account of the first user and process the activity request, when at least one of the first user and the second user tries to perform the activity. Further, the system authenticates the first user and/or the second user using the first account and/or the fourth account respectively, when the activity request is received from the first user and/or the second user. To that end, the system provided herein eliminates the vulnerabilities such as fraud and abuse in conducting various digital transactions. For instance, the system eliminates the vulnerabilities such as fraud and abuse, since the system authenticates the first user and the second user using the first account and the fourth account respectively that eliminates a possibility of an attacker posing as at least one of the first user and the second user. Furthermore, the system provided herein while authenticating the first user and/or the second user, acquires an approval from the first user and/or the second user and records the approval and the authentication result (in the identify verification database), which serves as the verifiable proof of an actual initiator of the activity. Accordingly, the system provided herein provides the non-repudiation guarantee to the relying party application database, which was seen missing in prior existing solutions to the problem of authority delegation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1A illustrates an overview of a system for managing a digital identity of a user, in accordance with one or more example embodiments.

FIG. 1B illustrates an overview of the system for managing digital identities of a plurality of entities, in accordance with one or more example embodiments.

FIG. 2A illustrates a block diagram showing an encryption algorithm for encrypting plaintext data, in accordance with one or more example embodiments.

FIG. 2B illustrates a block diagram of an envelope encryption module for encrypting the plaintext data, in accordance with one or more example embodiments.

FIG. 3A illustrates a block diagram showing a decryption algorithm for decrypting an encrypted blob, in accordance with one or more example embodiments.

FIG. 3B illustrates a block diagram of an envelope decryption module for decrypting the encrypted blob, in accordance with one or more example embodiments.

FIG. 4 illustrates a block diagram of the system for performing a delegation process, in accordance with one or more example embodiments.

FIG. 5A illustrates an account linking workflow for linking a first account of a first user with a second account of the first user, in accordance with one or more example embodiments.

FIG. 5B illustrates an account linking method for linking the first account of the first user with the second account of the first user, in accordance with one or more example embodiments.

FIG. 6A illustrates a delegation workflow for allocating, to the second user, the authority of the second account of the first user, in accordance with one or more example embodiments.

FIG. 6B illustrates a block diagram for an exemplary scenario for transmitting a delegation request from a mobile device to a relying party application database, in accordance with one or more example embodiments.

FIG. 6C illustrates a block diagram of the relying party application database for generating encrypted delegation request data in response to receiving the delegation request, in accordance with one or more example embodiments.

FIG. 7A illustrates an activity processing workflow for processing the activity request, when the second user tries to perform an activity, in accordance with one or more example embodiments.

FIG. 7B illustrates an activity processing method for processing the activity request, when the second user tries to perform the activity, in accordance with one or more example embodiments.

FIG. 8 illustrates a revocation workflow for revoking the authority of the second account from the second user, in accordance with one or more example embodiments.

FIG. 9 illustrates an audit log accessing workflow for accessing the encrypted delegation request data, in accordance with one or more example embodiments.

FIG. 10A illustrates an exemplary account storing message flow to copy, from a mobile device associated with the first user to a mobile device associated with the second user, the user data associated with the first user for account restoration, in accordance with one or more example embodiments.

FIG. 10B illustrates an exemplary scenario for recovering the user data associated with the first user from the mobile device associated with the second user to a new mobile device associated with the first user, in accordance with one or more example embodiments.

FIG. 11 illustrates an exemplary account restoring message flow for restoring, from an existing mobile device to a new mobile device, the user data associated with a user, in accordance with one or more example embodiments.

FIG. 12 illustrates a delegation method executed by the system for allowing the first user to delegate authority of their account to the second user to, in accordance with one or more example embodiments.

FIG. 13 illustrates a delegation request managing method executed by the relying party application database for managing the delegation request, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

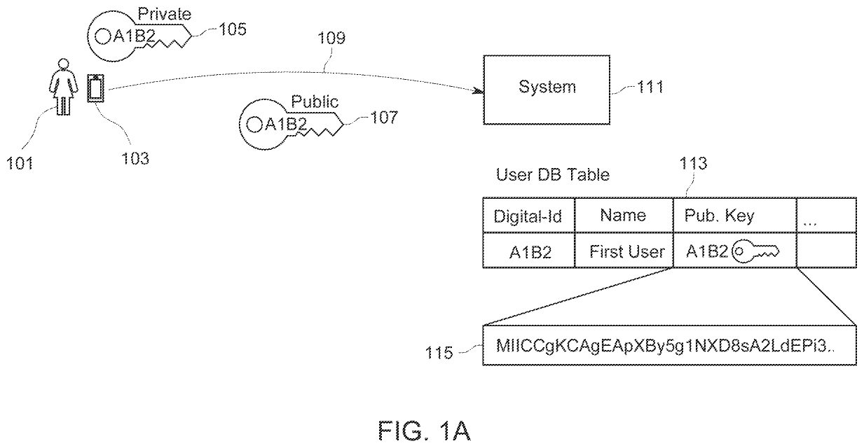

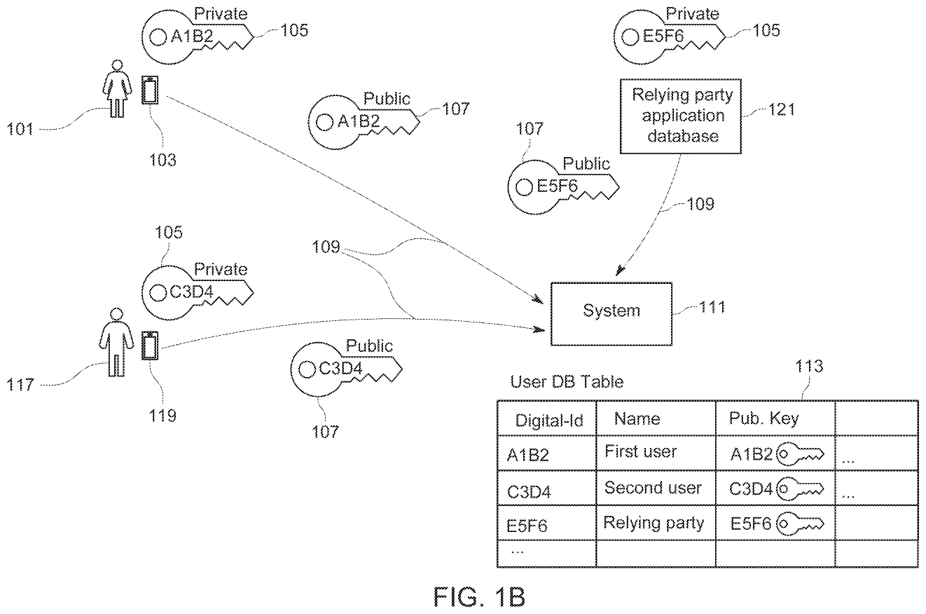

FIG. 1A illustrates an overview of a system 111 for managing a digital identity of a user 101, in accordance with one or more example embodiments. As illustrated in FIG. 1A, the user 101 may be associated with a mobile device 103. The mobile device 103 includes one or more processors, a memory, and I/O interface. The mobile device 103 corresponds to a smart phone, a laptop, a computer, a tablet, a smart watch, and the like. The mobile device 103 may be communicatively connected to the system 111 via a network. The network may be wired, wireless, or any combination of wired and wireless communication networks, such as cellular, Wi-Fi, internet, local area networks, or the like. The system 111 includes a server (for instance, a backend server, a remotely located server, or the like), group of servers, distributed computing system, and/or other computing system. The system 111 is configured to manage the digital identity of the user 101. Hereinafter, ‘system’ and ‘identity verification database’ may be interchangeably used to mean the same. The digital identity is indicative of an identity of the user 101 to uniquely identify the user 101 within the system 111 and to authenticate the user 101 in various applications such as financial transaction applications, medicine purchase applications, customer service applications, voter registration applications, retail purchase applications, on-line purchase applications and the like.

For example, the system 111 manages the digital identity of the user 101, after the user 101 creates, using the mobile device 103, an identity account (also referred to as a first account) within the system 111. For instance, the user 101 may install an identity software application (also referred to as a system app) associated with the system 101 on the mobile device 103 and creates the identity account for the user 101. As a process of creating the identity account, the system 111 requests the user 101 to provide user data associated with the user 101. The user data includes biometric data of the user 101 and user information associated with the user 101. The biometric data includes facial data (e.g. 2D or 3D facial landmarks) of the user 101, fingerprint data of the user 101, and the like. The user information includes a name of the user 101, date of birth of the user 101, mobile number of the user 101, email address of the user 101, government identity card data associated with the user 101, financial card data associated with the user 101, and the like. Additionally, the user data includes behavioral data of the user 101. For instance, the behavioral data includes static data and/or dynamic data associated with the user 101 such as gait data associated with the user 101, network connectivity data (e.g. the network used to connect the mobile device 103 to system 111), transaction data associated with the user 101, connectivity data associated with the user 101, location data associated with the user 101, and the like. Since the user data of the user 101 includes sensitive information of the user 101 that proves authenticity of the user 101, the user data is securely stored on mobile device 103 that is associated with the user 101 such that data breach, data theft, and the like are avoided.

Further, as a result of creating the identity account, the system 111 provides, using the mobile device 103, a cryptographic key pair and the digital identification (identity) of the user. The cryptographic key pair includes a private key 105 and a public key 107, which are cryptographically related to each other. For instance, the cryptographic key pair is a key pair that is used in Rivest-Shamir-Adleman (RSA) algorithm. The private key 105 is meant to be safeguarded or protected, and not to be seen by anyone except the user 101. To that end, the private key 105 is stored locally within an encrypted file on the mobile device 103. The public key 107 is meant to be shared or distributed freely such that the public key is accessible to anyone. To that end, a copy of the public key 107 along with the digital identity of the user 101 is sent to the system 111 from the mobile device 103 via a connection 109 (e.g. an Application Programming Interface (API) call).

The system 111 stores the digital identity of the user 101 and the public key 107 of the user 101 in a user database 113, after receiving the public key 105 and the digital identity from the mobile device 103. For instance, the public key 107 is a long base64 encoded string 115, which may be later decoded to yield a unique 4096-bit RSA public key. Additionally, the system 111 stores a name of the user 101, a mobile number of the user 101 and the like on the user database 113 along with the digital identity of the user 101 and the public key 107 of the user 101, if the mobile device 103 sends the name of the user 101, the mobile number of the user 101 and the like. The system 111 provided herein is not limited to store the digital identity of one particular user. For instance, the system 111 stores digital identities associated with a plurality of individual users and/or one or more relying parties as explained in the detailed description of FIG. 1B.

FIG. 1B illustrates an overview of the system 111 for managing digital identities of a plurality of entities, in accordance with one or more example embodiments. The plurality of entities includes one or more individual users and one or more relying parties. For instance, the plurality of entities includes the user 101 (also referred to as a first user 101), a user 117 (also referred to as a second user 117), and a relying party which is associated with a relying party application database 121. The relying party application database 121 may be associated with the relying party such as a business unit. For instance, the relying party includes a bank that executes financial transactions, a pharmacy that provides medicine, a private enterprise company, public agencies and the like. The relying party application database 121 may be a server (for instance, a backend server, a remotely located server, or the like), group of servers, distributed computing system, and/or other computing system. As explained in FIG. 1A, each of the plurality of entities creates an identity account within the system 111. As a result of creating the identity account, each of the plurality of entities securely stores the private key 105, shares their corresponding public key 107 and digital identity with the system 111 as explained in the detailed description of FIG. 1A. To that end, the system 111 stores the digital identities and their corresponding public keys of the plurality of entities in the user database table 113.

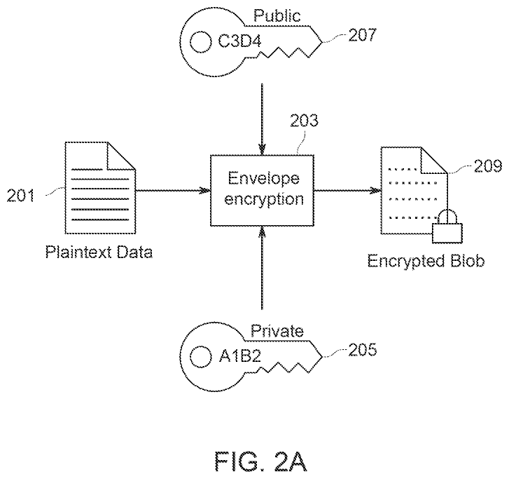

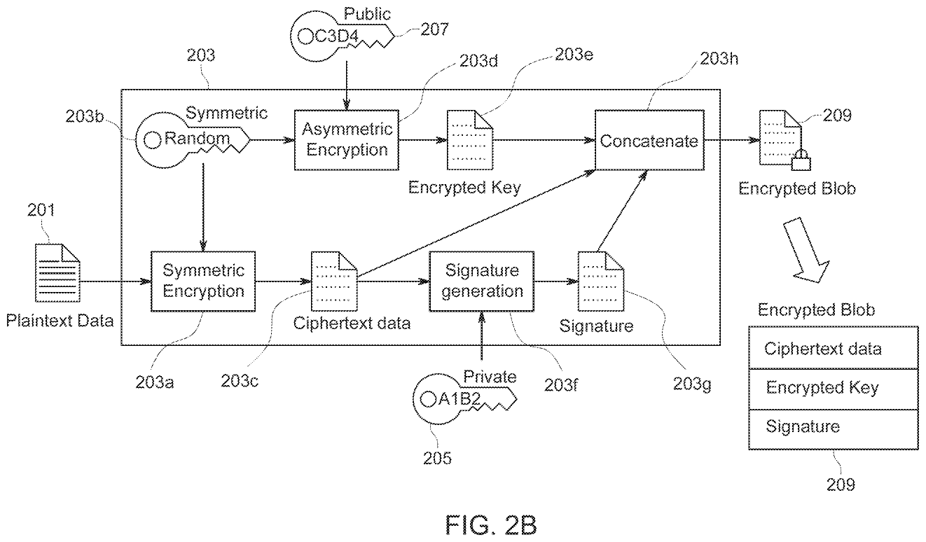

Further, the system 111 allows each of the plurality of entities to request a copy of the public key of another entity to securely exchange messages between the entities. In some embodiments, the system 111 uses the public key 105 of a particular entity to securely send message to that particular entity. Further, an encryption algorithm used by the system 111 or by any entity to securely exchange the message is as explained in the detailed description of FIG. 2A.

FIG. 2A illustrates a block diagram showing the encryption algorithm for encrypting plaintext data 201, in accordance with one or more example embodiments. As illustrated in FIG. 2A, an envelope encryption module 203 encrypts, using a private key 205 and a public key 207, the plaintext data 201 to provide an encrypted blob 209. The plaintext data 201 is a message that should be exchanged between the entities or between the system 111 and the entities. The private key 205 corresponds to the private key 105 of a sender. The public key 207 corresponds to the public key 107 of a recipient. The encrypted blob 209 corresponds to an encrypted version of the plaintext data 201, which is acquired by encrypting the plaintext data 201. Further, the envelope encryption module 203 for encrypting the plaintext data 201 is as explained in the detailed description of FIG. 2B.

FIG. 2B illustrates a block diagram of the envelope encryption module 203 for encrypting the plaintext data 201, in accordance with one or more example embodiments. The envelope encryption module 203 takes the plaintext data 201 as an input. The envelope encryption module 203 encrypts, using a symmetric encryption algorithm 203a, the plaintext data 201 for outputting a cipher-text data 203c. The symmetric encryption algorithm 203a (e.g. Advanced Encryption Standard-256 (AES256)) mathematically transforms the plaintext data 201 (e.g. a readable format) to the cipher-text data 203c (e.g. non-readable format) using a symmetric encryption key 203b. Thereby, the envelope encryption module 203 ensures confidentiality of the plaintext data 201. For instance, the envelope encryption module 203 ensures that the message is concealed from unintended third-parties. The symmetric encryption key 203b may be a fixed-length random byte sequence, generated on-demand at a time of symmetric encryption. Further, the envelop encryption module 203 ensures an integrity of the plaintext data 210 by performing a finite number of hashing iterations using hashes (or message digests). For instance, the envelop encryption module 203 ensures that the plaintext data 201 has not been altered/modified. The envelope encryption module 203 is configured to use symmetric encryption for encrypting the plaintext data 201 in comparison to asymmetric encryption, as the symmetric encryption is relatively faster than the asymmetric encryption for arbitrarily large payloads.

As the envelope encryption module 203 encrypts the plaintext data 201 with the symmetric encryption algorithm 203a, the symmetric encryption key 203b used in the symmetric encryption algorithm 203a is transmitted to the recipient of the cipher-text data 203c along with the cipher-text data 203c for decrypting the cipher-text data 203c at the recipient's end. To that end, the envelope encryption module 203 encrypts, using asymmetric encryption algorithm 203d, the symmetric encryption key 203b to output an encrypted key 203e. The asymmetric encryption algorithm 203d uses the public key 207 of the recipient to encrypt the symmetric encryption key 203b. Therefore, the envelope encryption module 203 further ensures that only intended receipt decrypts the cipher-text data 203c.

Furthermore, the envelope encryption module 203 digitally signs, using a signature generation algorithm 203f, the cipher-text data 203c to output a digital signature 203g. The signature generation algorithm 203f uses the private key 205 of the sender to digitally sign the cipher-text data 203c. As the cipher-text data is digitally signed with the private key 205 of the sender, the thus obtained digital signature 203g serves to prove authenticity of the sender. Therefore, the envelope encryption module 203 ensures the authenticity of the sender, using the cryptographic proof of the sender.

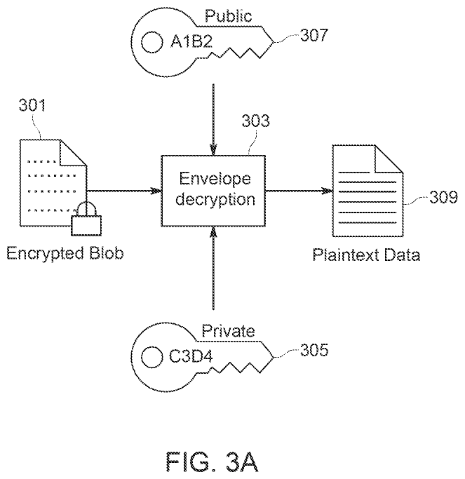

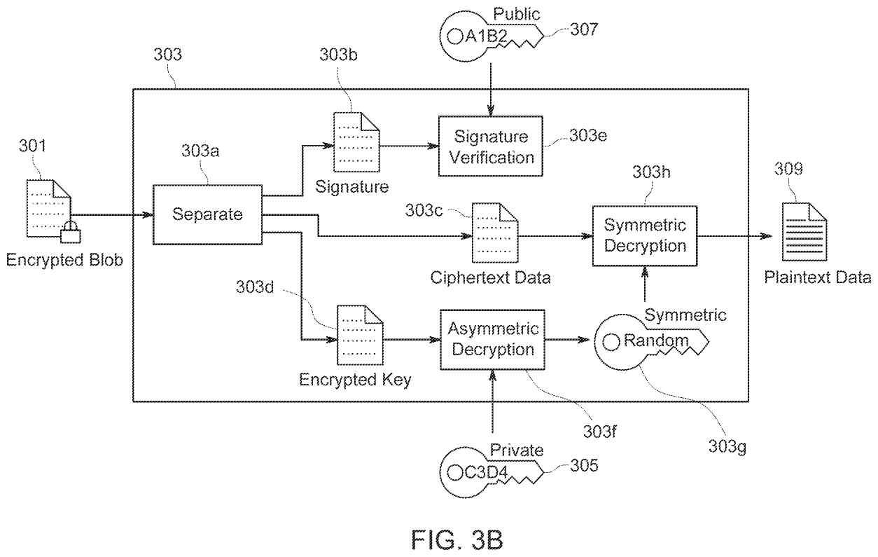

Furthermore, the envelope encryption module 203 concatenates, using a concatenation module 203h, the cipher-text data 203c, the encrypted key 203e, and the digital signature 203g to formulate the encrypted blob 209 (e.g. a single binary blob). Accordingly, the encrypted blob 209 comprises the cipher-text data 203c, the encrypted key 203e, and the digital signature 203g. The encrypted blob 209 may be exchanged between the entities via the system 111 and/or may be exchanged between the system 111 and the entities as a secured message. Further, a decryption algorithm used by the system 111 or by any entity to decrypt the encrypted blob 209 is as explained in the detailed description of FIG. 3A.

FIG. 3A illustrates a block diagram showing the decryption algorithm for decrypting an encrypted blob 301, in accordance with one or more example embodiments. As illustrated in FIG. 3A, an envelope decryption module 303 decrypts, using a private key 305 and a public key 307, the encrypted blob 301 to provide a plaintext data 309. For instance, the envelope decryption module 303 performs inverse operations of the encryption algorithm executed by the envelope encryption module 203. The encrypted blob 301 corresponds to the encrypted blob 209. The private key 305 corresponds to the private key 105 of the recipient. The public key 307 corresponds to the public key 107 of the sender. The plaintext data 309 corresponds to the plaintext data 201. Further, the envelop decryption module 303 for decrypting the encrypted blob 301 is as explained in the detailed description of FIG. 3B.

FIG. 3B illustrates a block diagram of the envelop decryption module 303 for decrypting the encrypted blob 301, in accordance with one or more example embodiments. The envelop decryption module 303 takes the encrypted blob 301 as an input. The envelop decryption module 303 separates using a separation module 303a, the encrypted blob 301 into a digital signature 303b, a cipher-text data 303c, and an encrypted key 303d. The digital signature 303b corresponds to the digital signature 203g. The cipher-text data 303c corresponds to the cipher-text data 203c. The encrypted key 303d corresponds to the encrypted key 203e.

The envelop decryption module 303 verifies the digital signature 303b to ensure that the encrypted blob 301 was signed by the intended sender. For instance, the envelope decryption module 303 inputs, into a signature verification algorithm 303e, the digital signature 303b along with a public key 307 of the intended sender for verifying the digital signature 303b. If the signature verification is negative, then the envelope decryption module 303 stops the decryption process and discards the encrypted blob 301 as the encrypted blob 301 is unreliable. For instance, the signature verification is negative, if the encrypted blob 301 is not signed by the intended sender.

If the signature verification is positive, then the envelop decryption module 303 extracts a symmetric decryption key 303g from the encrypted key 303d. For instance, the envelope decryption module 303 inputs, into an asymmetric decryption algorithm 303f, the encrypted key 303d along with the private key 305 of the recipient for extracting the symmetric decryption key 303g. The symmetric decryption key 303g corresponds to the symmetric encryption key 203b.

Further, the envelope decryption module 303 decrypts the cipher-text data 303c into the plaintext data 309. For instance, the envelop decryption module 303 inputs, into a symmetric decryption algorithm 303h, the cipher-text data 303c along with the symmetric decryption key 303g for decrypting the cipher-text data 303c into the plaintext data 309. Furthermore, the envelope decryption module 303 verifies the integrity of the plaintext data 309 by comparing the hash of the payload. Accordingly, the system 111 provided herein enables to securely exchange messages by providing an assurance on confidentiality of the messages, authenticity of the messages, and integrity of the messages.

Referring to FIG. 1B, for instance, when the user 101 tries to perform an activity associated with the relying party, the mobile device 103 transmits, to the relying party application database 121, an activity request for performing the activity. For instance, the activity includes access to protected data, a transaction and the like. The transaction includes a financial transaction, medicine purchase, and the like. The relying party application database 121 transmits, to the system 111, a request for authenticating the user 101 in response to receiving the activity request. The system 111 performs a lookup search on the database 113 to identify the digital identity and the public key 105 of the user 101. Further, the system 111 securely transmits, to the mobile device 103, an authentication request for authenticating the user 101. Upon receiving the authentication request, the mobile device 103 acquires live-selfie of the user 101. Further, the mobile device 103 authenticates, using the identity account of the user 101, the user 101 by comparing the live-selfie video with the facial data stored on the mobile device 103. Additionally, the mobile device 103 authenticates the user 101 by using the identity account of the user 101, by comparing current behavioral data (e.g. recently acquired behavioral data) with the behavioral data stored on the mobile device 103. The mobile device 103 securely transmits, to the system 111, an authentication response indicating an authenticity of the user 101. For instance, the authentication response indicates the user 101 as at least one of a valid user or invalid user. The system 111 checks whether the authentication response indicates the user 101 as the valid user. If the authentication response indicates the user as the valid user, the system 111 records and transmits, to the relying party application database 121, a response for conducting the activity. The relying party application database 121 conducts the activity for the user 101 after receiving the response from the system 111.

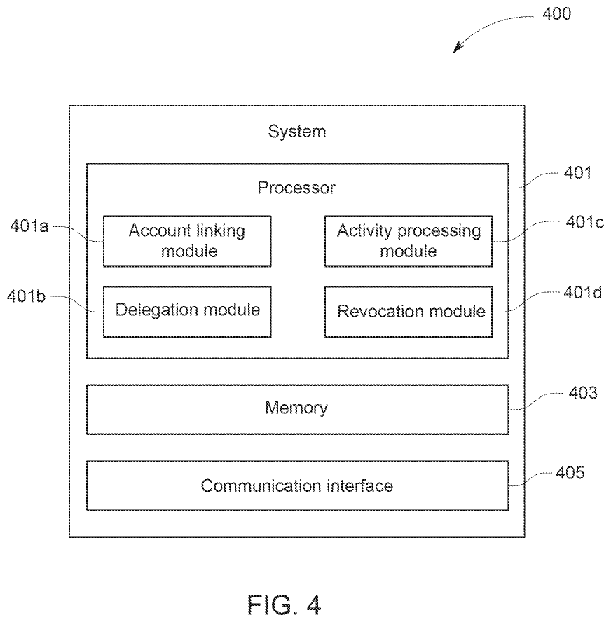

In this way, the system 111 manages the digital identities of the plurality of entities for identifying each entity within the system 111 and authenticating each entity while performing the activity. Further, the system 111 allows for securely exchanging the messages between the entities and between the system 111 and one or more entities by providing assurance on confidentiality of the messages, authenticity of the messages, and integrity of the messages. Furthermore, the system 111 may not be limited to identify one or more entities, authenticate one or more entities, and/or securely exchanges between entities. Indeed, the system 111 provided herein may be also used in a delegation process. As used herein, the delegation process (also referred to as a delegation method) is a process of allocating of an authority from one entity to another entity for performing the activity. Further, the system 111 for performing the delegation process is as explained in the detailed description of FIG. 4.

FIG. 4 illustrates a block diagram of a system 400 for performing the delegation process, in accordance with one or more example embodiments. The system 400 corresponds to the system 111. The system 400 includes a processing means such as at least one processor 401 and a storage means such as a memory 403. The processor 401 may be embodied in several different ways. For example, the processor 401 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 401 may include one or more processing cores configured to perform independently. A multi-core processor may enable multiprocessing within a single physical package. Additionally, or alternatively, the processor 401 may include one or more processors configured in tandem via a bus to enable independent execution of instructions, pipelining and/or multithreading.

Additionally, or alternatively, the processor 401 may include one or more processors capable of processing large volumes of workloads and operations to provide support for big data analysis. In an example embodiment, the processor 401 may be in communication with the memory 403 via a bus. The memory 403 may be non-transitory and may include, for example, one or more volatile and/or non-volatile memories. In other words, for example, the memory 403 may be an electronic storage device (for example, a computer readable storage medium) comprising gates configured to store data (for example, bits) that may be retrievable by a machine (for example, a computing device like the processor 401). The memory 403 may be configured to store information, data, content, applications, instructions, or the like, for enabling the system 400 to carry out various functions in accordance with an example embodiment of the present invention. Additionally, the memory 403 comprises one or more data modules that may be configured as user database 113 for storing the digital identities, the public keys, and the like. Further, the memory 403 may be configured to buffer input data for processing by the processor 401. As exemplarily illustrated in FIG. 4, the memory 403 may be configured to store computer-executable instructions for execution by the processor 401. As such, whether configured by hardware or software methods, or by a combination thereof, the processor 401 may represent an entity (for example, physically embodied in circuitry) capable of performing operations according to an embodiment of the present invention while configured accordingly. Thus, for example, when the processor 401 is embodied as an ASIC, FPGA or the like, the processor 401 may be specifically configured hardware for conducting the operations described herein. Alternatively, as another example, when the processor 401 is embodied as an executor of software instructions, the instructions may specifically configure the processor 401 to perform the algorithms and/or operations described herein when the instructions are executed. However, in some cases, the processor 401 may be a processor specific device (for example, a fixed computing device) configured to employ an embodiment of the present invention by further configuration of the processor 401 by instructions for performing the algorithms and/or operations described herein. The processor 401 may include, among other things, a clock, an arithmetic logic unit (ALU) and logic gates configured to support operation of the processor 401.

The processor 401 is configured as one or more of an account linking module 401a, a delegation module 401b, an activity processing module 401c, and a revocation module 401d while executing the computer-executable instructions stored on the memory 403. In some embodiments, the computer-executable instructions relate to an application or app, stored in the memory 403, which includes all the instructions configured to cause the processor 401 to operate the different modules and their functions embodied therein. The account linking module 401a is configured to link a first account (e.g. the identity account) of the first user (e.g. the user 101) with a second account of the first user. For instance, the second account of the first user may be an account associated with the relying party. The second account includes a transaction account such as a financial account associated with a financial institution, a pharmacy account associated with a pharmacy, and the like.

The delegation module 401b is configured to allocate, to a second user (e.g. the user 117), an authority to conduct a transaction for the second account of the first user, using the first account of the first user and a fourth account (e.g. the identity account) of the second user. The activity processing module 401c is configured to communicate authorization data associated with the second user. The authorization data comprises a message indicative of allocation of the authority of the second account of the first user to the second user. Further, the activity processing module 401c is configured to authenticate, using the fourth account of the second user, the second user in response to receiving, from the second user, an activity request to conduct the transaction for the second account of the first user. Furthermore, the activity processing module 401c is configured to process the activity request based on the authentication. The revocation module 401d is configured to revoke the authority of the second account from the second user in response to receiving, from the first account of the first user, a revocation request. Further, in some embodiments, the processor is configured to provide access to audit logs for the first user and/or the second user in response to receiving an audit request from the first account of the first user and/or the fourth account of the second user.

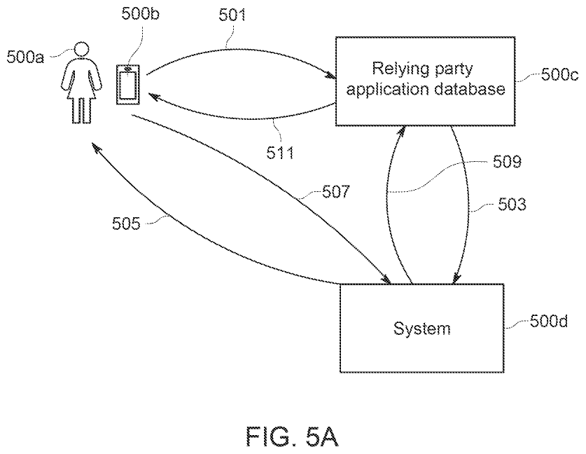

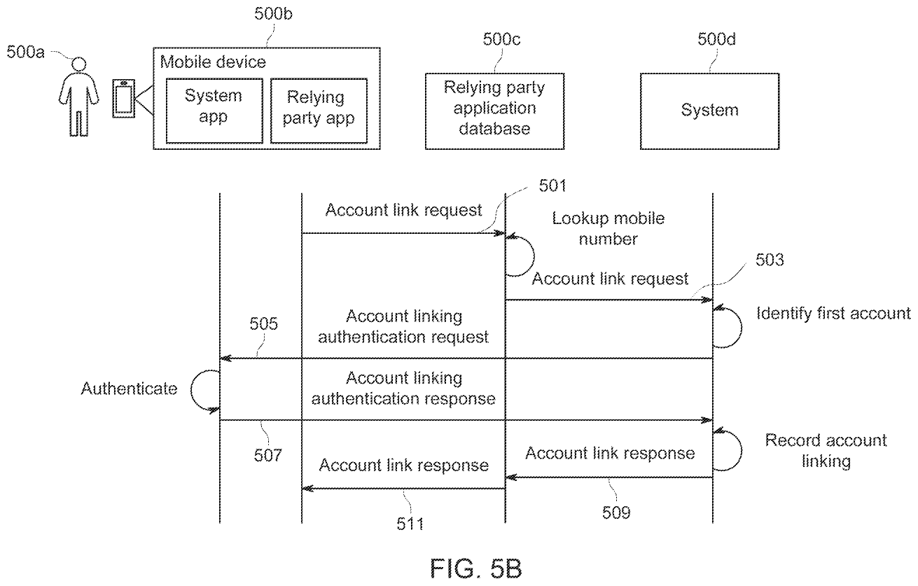

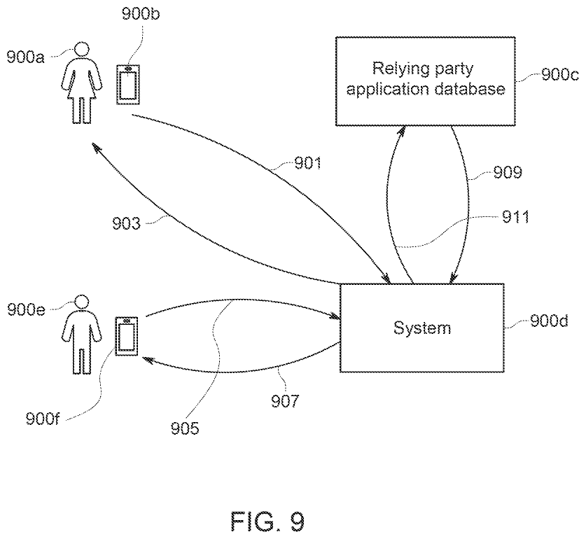

Additionally, the processor 401 is further configured as the envelop encryption module 203 and the envelope decryption module 303 for securely exchanging the messages between the entities. To that end, the system 400 provides the delegation process provided herein along with the additional assurance on the confidentiality of data, the authenticity of data, and the integrity of data. Further, steps or operations executed by each of the modules (401a-401d) are as explained in the detailed description of FIG. 5A—FIG. 9.

FIG. 5A illustrates an account linking workflow for linking the first account of a first user 500a with the second account of the first user 500a, in accordance with one or more example embodiments. As illustrated in FIG. 5A, the account linking workflow comprises a first user 500a, a mobile device 500b associated with the first user 500a, a relying party application database 500c, and a system 500d. The first user 500a corresponds to the user 101. The mobile device 500b corresponds to the mobile device 103. The relying party application database 500c corresponds to the relying party application database 121. The system 500d corresponds to the system 400. The account linking workflow implements an account linking method for linking the first account of the first user 500a with the second account of the first user 500a.

The account linking method comprises, at step 501, transmitting an account link request from the mobile device 500b to the relying party application database 500c. The account linking method comprises, at step 503, transmitting, from the relying party application database 500c to the system 500d, the account linking request along with personal information associated with the first user 500a. For instance, the relying party application database 500c identifies the personal information of the first user 500a and transmits the account linking request along with the personal information, after receiving the account linking request. The account linking method comprises, at step 505, transmitting, from the system 500d to the mobile device 500b, an account linking authentication request for authenticating the first user 500a. The account linking method comprises, at step 507, transmitting, from the mobile device 500b to the system 500d, an account linking authentication response indicating a result of authentication. Once the first user is successfully authenticated as a valid first user, the system 500d records the activity authentication response and links the first account of the first user 500a with the second account of the first user 500a. The account linking method comprises, at step 509, transmitting, from the system 500d to the relying party application database 500c, an account link response as a result of linking the first account with the second account. The account linking method comprises, at step 511, transmitting, from the relying party application database 500c to the mobile device 500b, a response indicative of successful completion of account linking process. The account linking method of the account linking workflow is further explained in detail with reference to FIG. 5B.

FIG. 5B illustrates the account linking method for linking the first account of the first user 500a with the second account of the first user 500a, in accordance with one or more example embodiments. Starting at step 501, the account linking method comprises sending, using a relying party application or a relying party website, the account link request to link the second account of the first user 500a with the first account of the first user 500a. For instance, the first user 500a initiates the account linking method by pressing a virtual button on the relying party app (or the relying party website) to link the second account of the first user 500a with the first account of the first user 500b, and then the mobile device 500b sends the account link request to the relying party application database 500c.

Upon receiving the account link request from the mobile device 500b, the relying party application database 500c performs a lookup search on a database associated with the relying party application database 500c for identifying the personal information (e.g. email address, mobile number, name, or the like) associated with the first user 500a that may be used to identify the first account of the first user 500a within the system 500d.

At step 503, the account linking method comprises transmitting, from the relying party application database 500c to the system 500d, the account link request along with the personal information. For instance, the system 500d receives the account link request along with the personal information from the second account of the first user 500a, via the relying party application database 500c. Upon receiving the account link request along with the personal information, the system 500d extracts the personal information and identifies the first account of the first user 500a using the personal information of the first user 500a.

If the system 500d fails to identify the first account of the firs user 500a, the system 500d sends an invitation to the email address and/or the mobile number associated with the first user 500a. The invitation includes a download link for downloading the system app associated with the system 500d. Once the system app is installed on the mobile device 500b, the first account of the first user 500a may be created as explained in the detailed description of FIG. 1A.

If the first account of the first user 500a is identified within the system 500d, the system 500d authenticates, using the first account of the first user 500a, the first user 500a. To that end, at step 505, the account linking method comprises transmitting, from the system 500d to the first account of the first user 500a, an account linking authentication request for acquiring a live-selfie video of the first user 500a and for acquiring an approval for the account request. The account linking authentication request comprises a message indicative of the account link request. For instance, the account linking authentication request may be transmitted as a push notification from the system 500d to the mobile device 500b.

Upon receiving the account linking authentication request on the mobile device 500b, the mobile device 500b displays, to the first user 500a, a notification indicating the account link request. If the first user 500a does not approves the account link request, the account link method comprises, at step 507, transmitting, from the first account of the first user 500a to the system 500d, an account linking authentication response indicating the account link request as an unapproved account link request. For instance, the system 500d receives the account linking authentication response indicating the account link request as the unapproved account link request from the mobile device 500b.

If the first user 500a approves the account link request, the mobile device 500b acquires the live-selfie video of the first user 500a and compares the live-selfie video of the first user 500a with the facial data of the first user 500a stored on the mobile device 500b for authenticating the first user 500a. Additionally, the mobile device 500b acquires recent behavioral data of the first user 500a and compares the recently acquired behavioral data with the behavioral data stored on the mobile device 500b for authenticating the first user 500a. As a result of comparing the live-selfie video with the facial data and/or the recently acquired behavioral data with the behavioral data stored on the mobile device 500b, a confidence score may be obtained. If the confidence score is above a threshold score, the mobile device 500b authenticates the first user 500a as a valid first user. If the confidence score is below the threshold score, the mobile device 500b authenticates the first user 500a as an invalid first user. In some other embodiments, once the first user 500a approves the account link request, the mobile device 500b may acquire the recent behavioral data of the first user 500a and a passive biometric data (such as a password or the like) from the first user 500a. Further, the mobile device 500b may compare the recent behavioral data of the first user 500a with the behavioral data stored on the mobile device 500b and compare the passive biometric data with passive biometric data stored on the mobile device 500b. As a result of comparing the recent behavioral data of the first user 500a with the behavioral data stored on the mobile device 500b and the passive biometric data with the passive biometric data stored on the mobile device 500b, the mobile device 500b may obtain the confidence score. If the confidence score is above the threshold score, the mobile device 500b authenticates the first user 500a as the valid first user. If the confidence score is below the threshold score, the mobile device 500b acquires the live-selfie video of the first user 500a and compares the live-selfie video of the first user 500a with the facial data of the first user 500a stored on the mobile device 500b. The mobile device 500b may again compute the confidence score, in response to comparing the live-selfie video of the first user 500a with the facial data of the first user 500a stored on the mobile device 500b and the comparing the recent behavioral data of the first user 500a with the behavioral data stored on the mobile device 500b. Further, the mobile device 500b authenticates the first user 500a as at least one of the valid first user and the invalid first user, by comparing the recently computed confidence score with the threshold score. In these embodiments, the live-selfie video of the first user 500a may be optionally acquired. Thereby, the mobile device 500b enables to reduce user friction by optionally acquiring the live-selfie video of the first user 500a.

Once the first user 500a is authenticated as at least one of the valid first user or the invalid first user, the account linking method comprises, at step 507, transmitting, from the first account of the first user 500a to the system 500d, the account linking authentication response. For instance, the system 500d receives the account linking authentication response from the first account of the first user 500a. The account linking authentication response indicates the first user as at least one of the valid first user and the invalid first user. Further, the account linking authentication response indicates the account link request as at least one of an approved account link request or the unapproved account link request. For instance, the account linking authentication response indicates the account link request as the approved account link request, if the first user 500a approves the account link request.

Upon receiving the authentication response indicating the first user as the valid first user and the account link request as the approved account link request, the system 500d links the first account of the first user 500a with the second account of the first user 500b. Further, the system 500d records that the first account of the first user 500a is linked to the second account of the first user 500a. If the authentication response indicates the first user as the invalid first user and/or the account link request as the unapproved account link request, the system 500b may terminate the account linking method.

At step 509, the account linking method comprises transmitting, from the system 500d to the relying party application database 500c, the account link response in response to linking the first account of the first user 500a with the second account of the first user 500a. The account link response comprises an account linking information. The account linking information includes the digital identity (e.g. a digital identity number) associated with the first user 500a and further includes a message indicative of the first account of the first user 500a is linked to the second account of the first user 500a. The relying party application database 500c records the account link response (e.g. the account linking information).

At step 511, the account linking method comprises transmitting, from the relying party application database 500c to the second account of the first user 500a, a response confirming that the first account of the first user 500a is linked to the second account of the first user.

On implementing the account linking method provided herein, the system 500d links the first account of the first user with the second account of the first user 500a. For instance, the account inking module 401a of the processor 401 is configured to link the first account of the first user with the second account of the first user 500a. Similarly, the system 500d may be configured to link the fourth account (e.g. an identity account) of the second user (e.g. the user 117) with a third account (e.g. the account associated with the relying party application database 500c) of the second user, when the account link request is received from the third account of the second user. Indeed, the system 500d enables, for any finite number of users, to link their corresponding identity account with their corresponding at least one account associated with the relying party application database 500c.

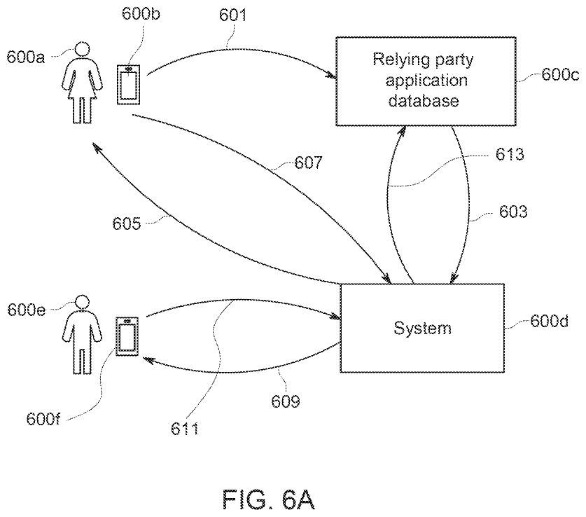

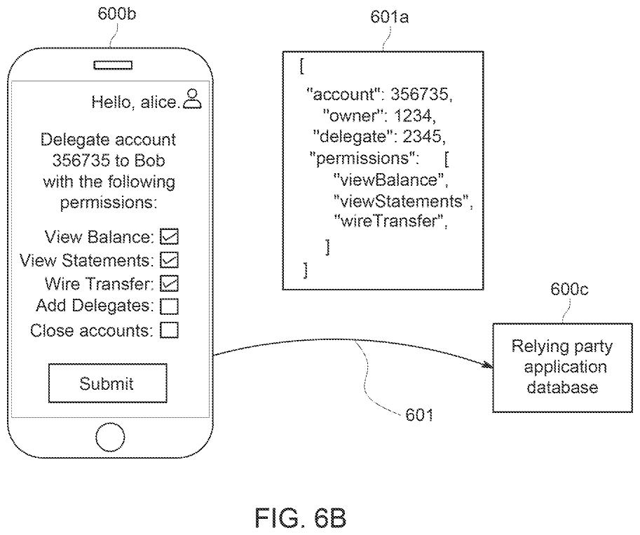

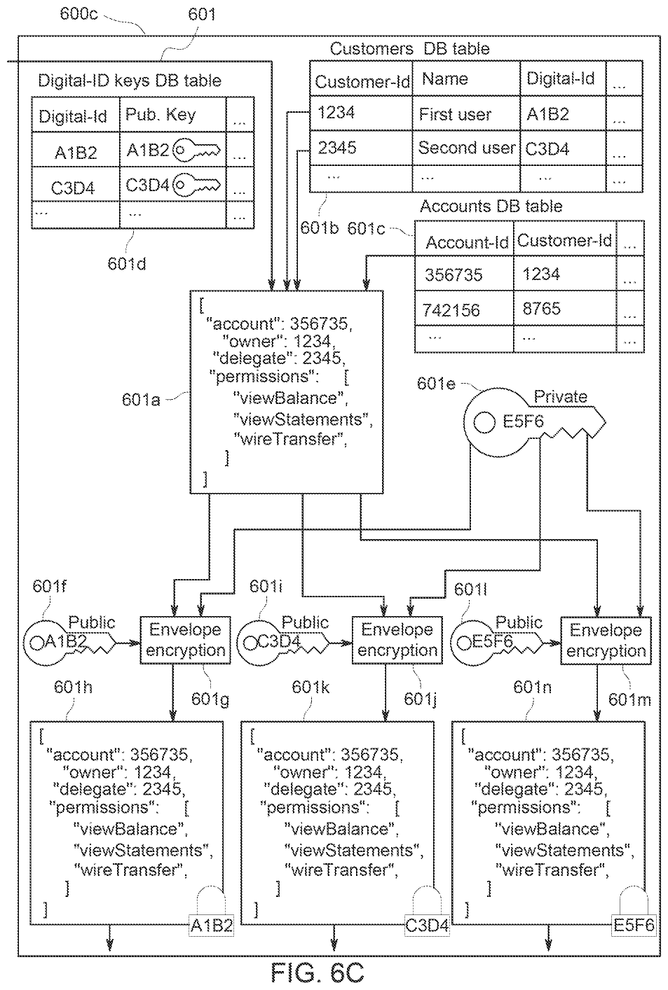

Once the first account of the first user 500a is linked to the second account of the first user 500a, the system 500d allows delegating the authority to conduct transactions using the second account of the first user 500b to at least one second user (e.g. the user 117) different from the first user. For instance, delegating the second account includes allocating, to the at least one second user, the authority to conduct the transaction using the second account. Further, steps or operations for delegating the second account of the first user 500b to the at least one second user are as explained in the detailed description of FIG. 6A.

FIG. 6A illustrates a delegation workflow for allocating, to a second user 600e, the authority of the second account of a first user 600a using the first account of the first user 600a and the fourth account of the second user 600a, in accordance with one or more example embodiments. As illustrated in FIG. 6A, the delegation workflow comprises a first user 600a, a mobile device 600b associated with the first user 600b, a relying party application database 600c, a system 600d, a second user 600e, and a mobile device 600f associated with the second user 600e. The first user 600a corresponds to the user 101. The mobile device 600b corresponds to the mobile device 103. The relying party application database 600c corresponds to the relying party application database 121. The system 600d corresponds to the system 400. The second user 600e corresponds to the user 117. The mobile device 600f corresponds to the mobile device 119.

The delegation workflow implements an account delegation method for allocating, to a second user 600e, the authority of the second account of a first user 600a using the first account of the first user 600a and the fourth account of the second user 600a. Starting at step 601, the account delegation method comprises transmitting, from the second account of the first user 600b to the relying party application database 600c, a delegation request using the relying party application or the relying party website. For instance, the mobile device 600b associated with the first user 600a transmits the delegation request to the relying party application database 600c. The delegation request comprises a delegation request payload. The delegation request payload comprises authorization data indicative of allocation of the authority, from the first user 600a to the second user 600e, to read-only access to the second account; authorization data indicative of allocation of the authority, from the first user 600a to the second user 600e, to conduct a transaction using the second account, and the like. Additionally, the delegation request payload comprises data associated with the second account of the first user 600a and the third account of the second user. For instance, the delegation request payload comprises second account details (e.g. second account ID (identity)) of the first user, a customer ID of the first user 600a, a customer ID of the second user 600e, and the authorization data (e.g. permissions that have been allocated to the second user 600e for using the second account of the first user 600a). Further, a schematic diagram for transmitting the delegation request is as explained in the detailed description of FIG. 6B.

FIG. 6B illustrates the schematic diagram for transmitting the delegation request from the mobile device 600b to the relying party application database 600c, in accordance with one or more example embodiments. For example, the first user 600a initiates the account delegation method by logging into the relying party application and by selecting a delegation option in the relying party app. In response selecting the delegation option, the mobile device 600b displays an interface as illustrated in FIG. 6B. The first user 600a (also referred to as an owner) may select the second user 600e (e.g. at least one delegate) and types of authority (or permissions) that can be allocated to the second user 600e. The mobile device 600b, at step 601, transmits the delegation request to the relying party application database 600c after the first user 600a selects the second user 600e and the types of authority. The delegation request comprises a delegation request payload 601a. The delegation request payload 601a comprises the second account ID (e.g. “account”: 356735), the customer ID of the first user 600a (e.g. “owner”: 1234), the customer ID of the second user 600e (e.g. “delegate”: 2345), and the permissions (e.g. “permission”: [“View Balance”, “View Statements”, “Wire Transfer”]). In response to receiving the delegation request, the relying party application database 600c is configured as explained in the detailed description of FIG. 6C.

FIG. 6C illustrates a schematic diagram of the relying party application database 600c for generating encrypted delegation request data in response to receiving the delegation request, in accordance with one or more example embodiments. As illustrated in FIG. 6C, the relying party application database 600c comprises at least three databases, for instance, a customer database 601b, an account database 601c, and a digital identity database 601d. In response to receiving the delegation request, the relying party application database 600c may be configured to extract the delegation request payload 601a from the delegation request. The relying party application database 600c is configured to verify the delegation request, based on the extracted delegation request payload 601a. To that end, the relying party application database 600c is configured to verify the identity data associated with each of the third account of the second user 600e and the second account of the first user 600a by mapping, using the customer database 601b, the customer ID of the first user 600a (e.g. customer ID: 1234) and the customer ID of the second user 600e (e.g. cutomer ID: 2345) in the extracted delegation request payload 601a with their corresponding digital identities. For example, the relying party application database 600c maps the customer ID: 1234 with a digital identity: A1B2 and the customer_ID:2345 with a digital identity: C3D4.

Further, the relying party application database 600c identifies a public key 601f of the first user 600a and a public key 601i of the second user 600e using the digital identity database 601d and the mapped digital identities (e.g. the digital identity: A1B2 and the digital identity: C3D4). Furthermore, the relying party application database 600c verifies an ownership of the second account of the first user 600a by using the account database 601c. For instance, the relying party application database 600c verifies whether the customer ID of the first user 600a and the second account ID in the delegation request payload 601a is matching with the customer_ID of the first user 600a and the account_ID respectively in the account database 601c.

Once the ownership of the second account is verified and the public keys are identified, the relying party application database 600c generates the encrypted delegation request data, for instance, at least three encrypted blobs. The encrypted delegation request data comprises a first encrypted data 601h, a second encrypted data 601k and a third encrypted data 601n. Each of the first encrypted data 601h, the second encrypted data 601k and the third encrypted data 601n comprises an encrypted message indicative of allocating the authority of the second account of the first user 600a to the second user 600e. The first encrypted data 601h is generated when the relying party application database 600c executes an envelope encryption module 601g. The envelope encryption module 601g corresponds to the envelope encryption module 203 explained in the detailed description of FIG. 2B. For instance, the envelope encryption module 601g generates the first encrypted data 601h using the extracted delegation request payload 601a (e.g. the plaintext data 201), the public key 601f of the first user 600a (e.g. the public key 207 of the recipient), and a private key 601e of the relying party application database 600c (e.g. the private key 205 of the sender).

The second encrypted data 601k is generated when the relying party application database 600c executes an envelope encryption module 601j. The envelope encryption module 601j corresponds to the envelope encryption module 203. For instance, the envelop encryption module 601j generates the second encrypted data 601k using the extracted delegation request payload 601a, the public key 601i of the second user 600e, and the private key 601e of the relying party application database 600c. The third encrypted data 601n is generated when the relying party application database 600c executes an envelope encryption module 601m. The envelope encryption module 601m corresponds to the envelope encryption module 203. For instance, the envelop encryption module 601m generates the third encrypted data 601n using the delegation request payload 601a, a public key 601l of the relying party application database 600c, and the private key 601e of the relying party application database 600c. Once the encrypted delegation request data (e.g. 601h, 601k, 601n) are generated by the relying party application database 600c, the account delegation method proceeds with step 603.

Referring to FIG. 6A, at step 603, the account delegation method comprises transmitting, from the relying party application database 600c to the system 600d, the encrypted delegation request data (e.g. the first encrypted data 601h, the second encrypted data 601k, and the third encrypted data 601n). To that end, the encrypted delegation request data is verified delegation request. Upon receiving the encrypted delegation request data, the system 600d records the encrypted delegation request data (e.g. 601h, 601k, 601n) and further authenticates, using the first account of the first user 600a, the first user 600a based on the first encrypted data 601h. To that end, at step 605, the account delegation method comprises transmitting, from the system 600d to the mobile device 600b, a first authentication request. For instance, the system 600d transmits the first authentication request to the first account of the first user 600a. The first authentication request comprises the first encrypted data 601h.

Upon receiving the first authentication request from the system 600d, the mobile device 600b decrypts the first encrypted data 601h using the decryption process explained in the detailed description of FIG. 3B. The mobile device 600b displays, to the first user 600a, a notification indicating the allocation of the authority of the second account of the first user 600a to the second user 600e. The mobile device 600b receives an approval from the first user 600a in response to displaying the notification indicating the allocation of the authority of the second account of the first user 600a to the second user 600e and authenticates the first user 600a as explained in the detailed description of FIG. 5B.

At step 607, the account delegation method comprises transmitting, from the mobile device 600b to the system 600d, a first authentication response. For instance, the system 600d receives the first authentication response from the first account of the first user 600a. The first authentication response is indicative of the authentication of the identity of the first user 600a. For instance, the first authentication response indicates the first user as at least one of the valid first user or the invalid first user. Further, the first authentication response indicates the delegation request as at least one of a first approved delegation request and a first unapproved delegation request.

If the first authentication response indicates the first user as the invalid first user and/or the delegation request as the first unapproved delegation request, the system 600d may terminate the delegation process.

If the first authentication response indicates the first user as the valid first user and the delegation request as the first approved delegation request, the system 600d records the first authentication response and further authenticates, using the fourth account of the second user 600e, the second user 600e based on the second encrypted data 601k. To that end, at step 609, the account delegation method comprises transmitting, from the system 600d to the mobile device 600f, a second authentication request. For instance, the system 600d transmits the second authentication request to the fourth account of the second user 600e. The second authentication request comprises the second encrypted data 601k.

Upon receiving the second authentication request from the system 600d, the mobile device 600f decrypts the second encrypted data 601k using the decryption process explained in the detailed description of FIG. 3B. The mobile device 600f displays, to the second user 600e, the notification indicating the allocation of the authority of the second account of the first user 600a to the second user 600e. The mobile device 600f receives an approval from the second user 600e in response to displaying the notification indicating the allocation of the authority of the second account of the first user 600a to the second user 600e and authenticates the second user 600e as explained in the detailed description of FIG. 5B.

At step 611, the account delegation method comprises transmitting, from the mobile device 600f to the system 600d, a second authentication response. For instance, the system 600d receives the second authentication response from the fourth account of the second user 600e. The second authentication response is indicative of the authentication of the identity of the second user 600e. For instance, the second authentication response indicates the second user as at least one of a valid second user or an invalid second user. Further, the second authentication response indicates the delegation request as at least one of a second approved delegation request and a second unapproved delegation request.

If the second authentication response indicates the second user as the invalid second user and/or the delegation request as the second unapproved delegation request, the system 600d may terminate the delegation process.

If the second authentication response indicates the second user as the valid second user and the delegation request as the second approved delegation request, the system 600d records the second authentication response. In an embodiment, the system 600d allocates the authority of the second account of the first user 600a to the second user 600e in response to receiving the second authentication response indicating the second user as the valid second user and the delegation request as the second approved delegation request.

At step 613, the account delegation method comprises transmitting, from the system 600d to the relying party application database 600c, a delegation response. The delegation response is a message indicative of successful completion of the delegation process. Additionally, the system 600d may transmit the delegation response to the first account of the first user 600a. In an alternate embodiment, the account delegation method, at step 613, includes transmitting, from the system 600d to the relying party application database 600c, an authentication response for allocating the authority of the second account of the first user 600a to the second user 600e. The authentication response comprises the first authentication response indicating the authentication of the identity of the first user 600a, the second authentication response indicating the authentication of the identity of the second user 600e, and confirmation data indicating confirmation of delegation of authority of the second account to the second user 600e. Upon receiving the authentication response, the relying party application database 600c allocates the authority of the second account of the first user 600a to the second user 600e.

On implementing the account delegation method provided herein, the system 600d may allocate, to the second user 600e, the authority of the second account of the first user 600a, using the first account of the first user 600a and the fourth account of the second user 600e. For instance, the delegation module 401b of the processor 401 is configured to allocate, to the second user 600e, the authority of the second account of the first user 600a, using the first account of the first user 600a and the fourth account of the second user 600e.

For purpose of explanation, in FIG. 6A-FIG. 6C, the first user 600a initially specifying the second user 600e (i.e., the delegate) and the authorities (i.e., the permissions) that can be allocated to the second user 600e is considered. However, according to some implementations, the first user 600a may specify the authorities that the first user 600a wishes to delegate, but may not specify details about the second user 600e to whom he wants to delegate. In these implementations, the delegation request payload 601a may only comprise the customer ID of the first user 600a (e.g. “owner”: 1234), and the permissions (e.g. “permission”: [“View Balance”, “View Statements”, “Wire Transfer”]). Thereby, the relying party application database 600c may generate only one encrypted data (e.g. the third encrypted data 601n) and may forward the encrypted data to store on the system 600d. Later, when the first user 600a specifies the details about the second user 600e, the system 600d may be configured to generate the first encrypted data 601h and the second encrypted data 601k. According to an embodiment, the system 600d may generate the first encrypted data 601h and the second encrypted 601k using a polymorphic encryption technique. For instance, the polymorphic encryption technique may be a technique in which the encryption algorithm (or the decryption algorithm) may change each time, when the encryption algorithm is used. Further, the polymorphic encryption technique may provide a similar output (e.g., an encrypted data) for a similar key (e.g., a public key), even if the encryption algorithm varies.

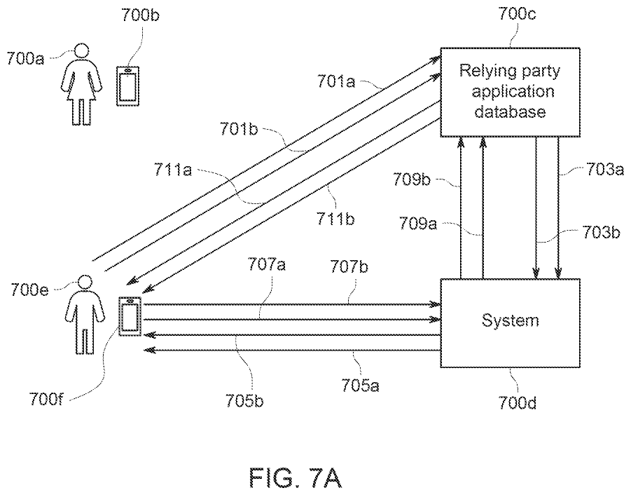

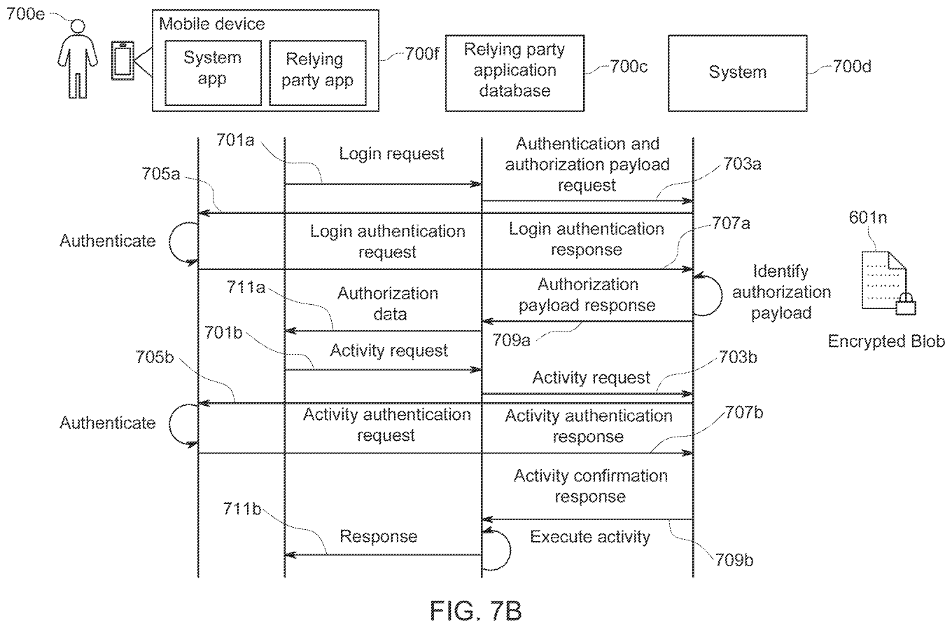

In this way, the system 600d securely enables the first user 600a to delegate his/her second account (e.g. the account associated with the relying party application database 600c) to the second user 600e for performing the activity on-behalf of the first user 600a. For instance, the system 600d securely enables an owner to delegate his/her a pharmacy account associated with the pharmacy to their at least one relying partner (e.g. a family member, friend, etc.) for purchasing a medicine on-behalf of the owner. For instance, the system 600d securely enables the owner (e.g. Chief Financial Officer (CFO)) to delegate his/her a financial account associated with the financial institution to their at least one relying partner (e.g. a financial director) for one or more financial activities. The one or more financial activities comprise accessing a financial statement of the financial account, conducting a financial transaction using the financial account, and the like. Further, when at least one of the first user 600a and/or the second user 600e tries to perform the activity, steps or operations for processing an activity request to perform the activity are as explained in the detailed description of FIG. 7A.

FIG. 7A illustrates an activity processing workflow for processing the activity request, when a second user 700e tries to perform the activity, in accordance with one or more example embodiments. As illustrated in FIG. 7A, the activity processing workflow comprises a first user 700a, a mobile device 700b associated with the first user 700a, a relying party application database 700c, a system 700d, a second user 700e, and a mobile device 700f associated with the second user 700e. The first user 700a corresponds to the user 101. The mobile device 700b corresponds to the mobile device 103. The relying party application database 700c corresponds to the relying party application database 121. The system 700d corresponds to the system 400. The second user 700e corresponds to the user 117. The mobile device 700f corresponds to the mobile device 119. The activity processing workflow implements an activity processing method for processing the activity request, when the second user 700f tries to perform the activity.

The activity processing method comprises, at step 701a, transmitting, from the mobile device 700f to the relying party application database 700c, a login request. For instance, the login request may be generated when the second user 700e tries to login into the relying party app. The activity processing method comprises, at step 703a, transmitting, from the relying party application database 700c to the system 700d, an authorization payload request. Upon receiving the authorization payload request, the activity processing method comprises, at step 705a, transmitting, from the system 700d to the mobile device 700f, a login authentication request for authenticating the second user 700e. The activity processing method comprises, at step 707a, transmitting, from the mobile device 700f to the system 700d, a login authentication response indicative of a result of authentication of the identity of the second user 700e. Once the second user 700e is authenticated as the valid second user, the activity processing method comprises, at step 709a, identifying the third encrypted data 601n and communicating, from the system 700d to the relying party application database 700c, the third encrypted data 601n as the authorization data associated with the second user 700e. The activity processing method comprises, at step 711a, communicating, from the relying party application database 700c to the mobile device 700f, the authorization data associated with the second user 700e.

The activity processing method comprises, at step 701b, transmitting, from the mobile device 700f to the relying party application database 700c, an activity request for the second account of the first user 700a. The activity processing method comprises, at step 703b, forwarding, from the relying party application database 700c to the system 700d, the activity request for confirming the authorization of the activity request. The activity processing method comprises, at step 705b, transmitting, from the system 700d to the mobile device 700f, an activity authentication request for authenticating the second user 700e. The activity processing method comprises, at step 707b, transmitting, from the mobile device 700f to the system 700d, an activity authentication response indicative of a result of authentication of the identity of the second user 700e. Once the second user 700e is authenticated as the valid second user, the activity processing method comprises, at step 709b, an activity confirmation response for performing the activity. Upon receiving the activity confirmation response for performing the activity, the relying party application database 700c executes the activity. The activity processing method comprises, at step 711b, transmitting, from the relying party application database 700c to the mobile device 700f, a response indicative of successful completion of the activity, after executing the activity. The activity processing method of the activity processing workflow is further explained in detail with reference to FIG. 7B.

FIG. 7B illustrates the activity processing method for processing the activity request, when the second user 700e tries to perform the activity, in accordance with one or more example embodiments. Starting at step 701a, the activity processing method comprises transmitting, from the mobile device 700f to the relying party application database 700c, the login request. For instance, the second user 700e initiates the activity processing method by logging into the relying party app or the relying party website via the system app, and then the mobile device 700f transmits, to the relying party application database 700c, the login request from the third account (e.g. the pharmacy account or the financial account) of the second user 700e.

At step 703a, the activity processing method comprises transmitting, from the relying party application database 700c to the system 700d, an authentication request and the authorization payload request. For instance, the relying party application database 700c converts the login request received from the third account of the second user 700e into the authentication request and the authorization payload request. Further, the relying party application database 700c transmits the authentication request and the authorization payload request to the system 700d.

Upon receiving the authentication request and the authorization payload request from the relying party application database 700c, the system 700d authenticates, using the fourth account of the second user 700e, the second user 700e. To that end, at step 705a, the activity processing method comprises transmitting, from the system 700d to the mobile device 700f, the login authentication request. For instance, the system 700d transmits the login authentication request to the third account of the second user 700e. For instance, the login authentication request may be transmitted as the push notification from the system 700d to the mobile device 700f.

Upon receiving the login authentication request from the system 700d, the mobile device 700f acquires the live-selfie video of the second user 700e and compares the live-selfie video of the second user 700e with a facial data of the second user 700e stored on the mobile device 700f for authenticating the second user 700e. Additionally, the mobile device 700f acquires recent behavioral data of the second user 700e and compares the recently acquired behavioral data with the behavioral data stored on the mobile device 700f for authenticating the second user 700e. As a result of comparing the live-selfie video of the second user 700e with the facial data stored on the mobile device 700f and/or the recently acquired behavioral data with the behavioral data stored on the mobile device 700f, the confidence score may be obtained. If the confidence score is above the threshold score, the mobile device 700f authenticates the second user 700e as the valid second user. If the confidence score is below the threshold score, the mobile device 700f authenticates the second user 700e as the invalid second user.

Once the second user 700e is authenticated as at least one of the valid second user or the invalid second user, at step 707a, the activity processing method comprises transmitting, from the mobile device 700f to the system 700d, the login authentication response. The login authentication response indicates the second user as at least one of the valid second user or the invalid second user.

If the authentication response indicates the second user as the valid second user, the system 700d performs a lookup search for identifying at least one of the first encrypted data 601h, the second encrypted data 601k, and the third encrypted data 601n. In an example embodiment, the system 700d identifies the third encrypted data 601n (e.g. the encrypted blob encrypted with the pubic key of the relying party application database 700c) for transmitting to the relying party application database 700c.

At step 709a, the activity processing method comprises communicating, from the system 700d to the relying party application database 700c, the authorization payload response. The authorization payload response comprises the third encrypted data 601n as the authorization data associated with the second user 700e. Upon receiving the authorization payload response from the system 700d, the relying party application database 700c decrypts the third encrypted data 601n using the decryption process explained in the detailed description of FIGS. 3A-3B.

At step 711a, the activity processing method comprises communicating, from the relying party application database 700c to the mobile device 700f, the authorization data. The authorization data includes the second account details of the first user 700a and permissions that the second user 700e is allocated to perform using the second account of the first user 700a. Additionally, the authorization data comprises a login response, a list of accounts, and the like. The mobile device 700f displays the list of accounts and the permissions that the second user 700e is allocated. For instance, the mobile device 700f displays, using the relying party app or the relying party web site, the second account details of the second account of the first user 700a and the permissions that the second user 700e is allocated to perform using the second account of the first user 700a.

At step 701b, the activity processing method comprises transmitting, from the mobile device 700f to the relying party application database 700c, the activity request for performing the activity when the second user 700e tries to perform the activity using the second account of the first user 700a. At step 703b, the activity processing method comprises forwarding, from the relying party application database 700c to the system 700d, the activity request for confirming the authorization of the activity request. For instance, the system 700d receives the activity request for the second account of the first user 700a from the second user 700e via the relying party application database 700c.

Upon receiving the activity request, the system 700 records the activity request and authenticates, using the fourth account of the second user 700e, the second user 700e. To that end, at step 705b, the activity processing method comprises transmitting, from the system 700d to the mobile device 700f, the activity authentication request for acquiring the live-selfie video of the second user 700e and for acquiring an approval on the activity request from the second user 700e. For instance, the system 700d transmits the activity authentication request to the fourth account of the second user 700e. The activity authentication request comprises a message indicative of the activity request. For instance, the activity authentication request may be transmitted as the push notification from the system 700d to the mobile device 700f.

Upon receiving the activity authentication request on the mobile device 700f, the mobile device 700f displays, to the second user 700e, a notification indicating the activity request. If the second user 700e does not approves the activity request, the activity processing method comprises, at step 707b, transmitting, from the fourth account of the second user 700e to the system 700f, the activity authentication response indicating the activity request as an unapproved activity request. For instance, the system 700d receives the activity authentication response indicating the activity request as the unapproved activity request from the mobile device 700f.

If the second user 700e approves the activity request, the mobile device 700f acquires the live-selfie video of the second user 700e and compares the live-selfie video of the second user 700e with the facial data of the second user 700e stored on the mobile device 700f for authenticating the second user 700e. Additionally, the mobile device 700f acquires recent behavioral data of the second user 700e and compares the recently acquired behavioral data with the behavioral data stored on the mobile device 700f for authenticating the second user 700e. As a result of comparing the live-selfie video of the second user 700e with the facial data of the second user 700e and/or the recently acquired behavioral data with the behavioral data stored on the mobile device 700f, the confidence score may be obtained. If the confidence score is above the threshold score, the mobile device 700f (e.g. the fourth account of the second user 700e) authenticates the second user 700e as the valid second user. If the confidence score is below the threshold score, the mobile device 700f authenticates the second user 700e as the invalid second user.

Once the second user 700e is authenticated as at least one of the valid second user or the invalid second user, at step 707b, the activity processing method comprises transmitting, from the fourth account of the second user 700e to the system 700d, the activity authentication response. For instance, the system 700d receives the activity authentication response from the fourth account of the second user 700e. The activity authentication response is indicative of authentication of the identity of the second user 700e. For instance, the activity authentication response indicates the second user as at least one of the valid second user and the invalid second user. Further, the activity authentication response indicates the activity request as at least one of an approved activity request or the unapproved activity request. For instance, the activity authentication response indicates the activity request as the approved activity request, if the second user 700e approves the activity request.

Upon receiving the activity authentication response indicating the first user as the valid first user and the account link request as the approved account link request, the system 700d records the activity authentication response. The system 700d may provide the activity authentication response as the verifiable proof to prove the actual initiator of the activity. Accordingly, the system 700d provides the non-repudiation to the relying party application database 600c, when the second user 700e and the first user 700a claims that they have no knowledge or authorization of the activity, and blames at other about the activity. Further, the system 700d generates the activity confirmation response for performing the activity, if the activity authentication response indicates the first user as the valid first user and the account link request as the approved account link request. The system 700d generates an activity cancellation response to not perform the activity, if the authentication response indicates the first user as the invalid first user and/or the account link request as the unapproved account link request.

At step 709b, the activity processing method comprises transmitting, from the system 700d to the relying party application database 700c, the activity confirmation response or the activity cancellation response. Upon receiving the activity confirmation response, the relying party application database 700c executes the activity. The activity confirmation response comprises the activity authentication response indicating authentication of the identity of the second user and a message indicative of authorization of the second user to conduct the transaction using the second account. The relying party application database 700c may not execute the activity, if the relying party application receives the activity cancellation response.

At step 711b, the activity processing method comprises transmitting, from the relying party application database 700c to the mobile device 700f, a response indicative of successful completion of the activity after the relying party application database 700c executes the activity.

On implementing the activity processing method provided herein, the system 700d process the activity request when the second user 700e tries to perform the activity. For instance, the activity processing module 401c of the processor 401 is configured to process the activity request when the second user 700e tries to perform the activity.

In this way, the system 700d enables the first user 700a to delegate his/her second account to the second user 700e and process the activity request, when the second user tries to perform the activity using the second account of the first user 700a. For instance, the system 700d allows the first user 700a to delegate a permission, to the second user 700e, to perform a prescription pick-up activity in a desired pharmacy as explained in the detailed description of FIG. 6A. Further, when the second user reaches the pharmacy to perform the prescription pick-up activity on-behalf of the firs user 700a, the system 700a processes the prescription pick-up activity as explained in the detailed description of FIG. 7B.

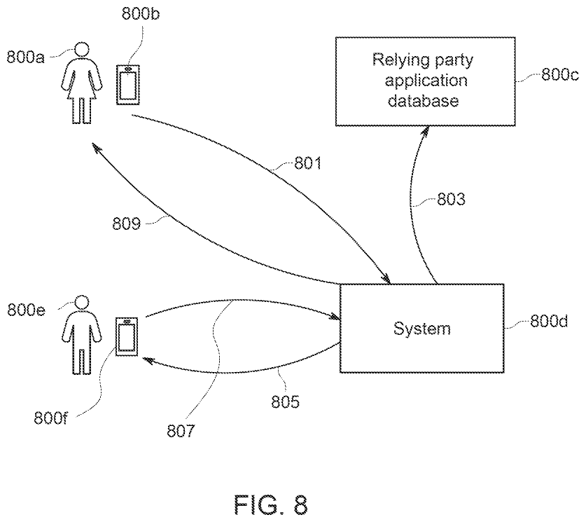

Further, the system 700d executes the delegation process (e.g. the account linking method, the account delegation method, and the activity processing method) provided herein by providing the additional assurance on the confidentiality of the messages, the authenticity of the messages, and the integrity of the messages, as the system 700d enables to securely exchange the messages between the entities and/or between the system 700d and the entity. Further, the system 700d authenticates the first user 700a and/or the second user 700e using the first account of the first user 700a and/or the fourth account of the second user 700a respectively, when the system receives a request from the first user and/or the second user. To that end, the system 700d eliminates the vulnerabilities such as fraud and abuse, as the system 700d authenticates the first user and the second user using the first account and the fourth account respectively that eliminates a possibility of an attacker posing as the first user and the second user. Furthermore, the system 700d while authenticating the first user and/or the second user, the system 700d acquires an approval from the first user and/or the second user and records the approval and the authentication result, which serves as the verifiable proof to prove the actual initiator of the activity. Accordingly, the system 700d provides the non-repudiation to the relying party when the second user 700e and the first user 700a claims that they have no knowledge or authorization of the activity, and blames at other about the activity. Furthermore, the system 700d allows the first user 700a to revoke the authorities that were allocated to the second user 700b. For instance, steps or operations for revoking the authorities from the second user 700b may be as explained in the detailed description of FIG. 8.

FIG. 8 illustrates a revocation workflow for revoking the authority of the second account from a second user 800e, in accordance with one or more example embodiments. As illustrated in FIG. 8, the revocation workflow comprises a first user 800a, a mobile device 800b associated with the first user 800a, a relying party application database 800c, a system 800d, a second user 800e, and a mobile device 800f associated with the second user 800e. The first user 800a corresponds to the user 101. The mobile device 800b corresponds to the mobile device 103. The relying party application database 800c corresponds to the relying party application database 121. The system 800d corresponds to the system 400. The second user 800e corresponds to the user 117. The mobile device 800f corresponds to the mobile device 119. The revocation workflow implements a revocation method for revoking, from the second user 800e, the authority of the second account of the first user 800a. Starting at step 801, the revocation method comprises transmitting, from the first account of the first user 800a, a revocation request. For instance, the first user 800a initiates the revocation method by invoking a revocation option, when the first user 800a wants to revoke the authorities that were allocated to the second user 800e on the second account of the first user 800a, and then mobile device 800b transmits the revocation request to the system 800d.

Upon receiving the revocation request from the first account of the first user 800a, the system 800d records the revocation request. In an embodiment, the system 800d revokes, from the second user 800e, the authority of the second account of the first user 800a in response to receiving the revocation request.

At step 803, the revocation method includes transmitting, from the system 800d to the relying party application database 800c, a first revocation notification for informing the relying party application database 800d about a change in the permissions allocated to the second user 800e. For instance, the system 800d transmits, to the relying party application database 800d, the first revocation notification through an asynchronous API call. For instance, the first revocation notification comprises a message indicative of revocation of the authority from the second user 800e on the second account of the first user 800a.

At step 805, the revocation method comprises transmitting, from the system 800d to fourth account of the second user 800e, a second revocation notification. For instance, the system 800d transmits second revocation notification to the mobile device 800f. Upon receiving the second revocation notification on the mobile device 800f, the system app on the mobile device 800f configures the mobile device 800f to remove stored data that is associated with the permissions that were allocated to the second user 800e on the second account of the first user 800a.

At step 807, the revocation method comprises transmitting, from the fourth account of the second user 800e to the system 800d, a response indicative of removal of the stored data that is associated with the permissions. Upon receiving the response from the mobile device 800f, the system 800d records the response.

At step 809, the revocation method comprises transmitting, from the system 800d to the first account of the first user 800a, a revocation response. For instance, the system 800d transmits the revocation response to the mobile device 800b. The revocation response comprises a message indicative of successful completion of revocation of the authority from the second user 800e on the second account of the first user 800a.

On implementing the revocation method provided herein, the system 800d is configured to revoke the authority from the second user 800e on the second account of the first user 800a. For instance, the revocation module 401d of the processor 401 is configured to revoke the authority from the second user 800e on the second account of the first user 800a.

In this way, the system 800d allows the first user 800a (e.g. the owner) to revoke the authorities allocated to the second user 800e on the second account of the first user 800e, when the first user 800a wants to revoke the authorities allocated to the second user 800e. Further, the system 800d allows each of the entities involved in the delegation process to request the encrypted delegation request data to verify the permissions allocated at a time of delegation. For instance, steps or operations of accessing the encrypted delegation request data are as explained in the detailed description of FIG. 9.

FIG. 9 illustrates an audit log accessing workflow for accessing the encrypted delegation request data, in accordance with one or more example embodiments. The audit log accessing workflow comprises a first user 900a, a mobile device 900b associated with the first user 900a, a relying party application database 900c, a system 900d, a second user 900e, and a mobile device 900f associated with the second user 900e. The first user 900a corresponds to the user 101. The mobile device 900b corresponds to the mobile device 103. The relying party application database 900c corresponds to the relying party application database 121. The system 900d corresponds to the system 400. The second user 900e corresponds to the user 117. The mobile device 900f corresponds to the mobile device 119.

When the first user 900a wants to check the authorities that the first user 900a has delegated to the second user 900e on the second account of the first user 900a, the first user 900a initiates the audit log accessing workflow at step 901, by transmitting an audit request from the first account of the first user 900a to the system 900d. Upon receiving the audit request from the first account of the first user 900a, the system 900d, at step 903, transmits the first encrypted data (e.g. the first encrypted data 601h) to the first account of the first user 900a. After receiving the first encrypted data, the mobile device 900b decrypts the first encrypted data using the decryption process explained in the detailed description of FIG. 3B.

When the second user 900b wants to check the authority that were delegated to the second user 900e from the first user 900a on the second account of the first user 900a, the second user 900e initiates the audit log accessing workflow at step 905, by transmitting the audit request from the fourth account of the second user 900e to the system 900d. Upon receiving the audit request from the fourth account of the second user 900e, the system 900d, at step 907, transmits the second encrypted data (e.g. the first encrypted data 601k) to the fourth account of the second user 900e. After receiving the second encrypted data, the mobile device 900f decrypts the second encrypted data using the decryption process explained in the detailed description of FIG. 3B.

When the relying party application database 900c wants to check the authority that were delegated to the second user 900e from the first user 900a on the second account of the first user 900a, the relying party application database 900c initiates the audit log accessing workflow at step 909, by transmitting the audit request to the system 900d. Upon receiving the audit request from the relying party application database 900c, the system 900d, at step 911, transmits the third encrypted data (e.g. the third encrypted data 601n) to relying party application database 900c. After receiving the third encrypted data, the relying party application database 900c decrypts the third encrypted data using the decryption process explained in the detailed description of FIG. 3B.

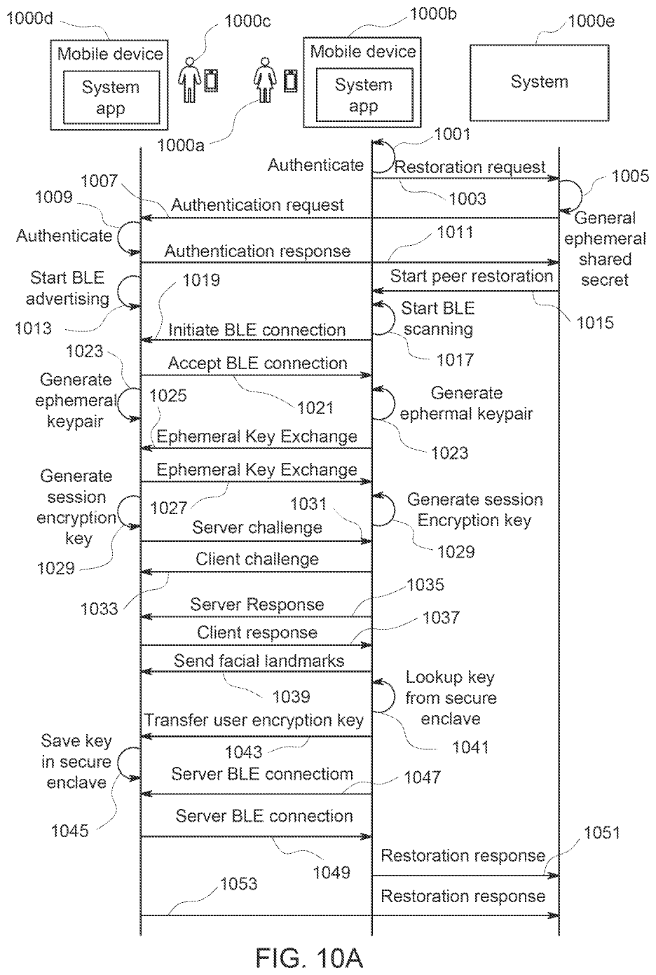

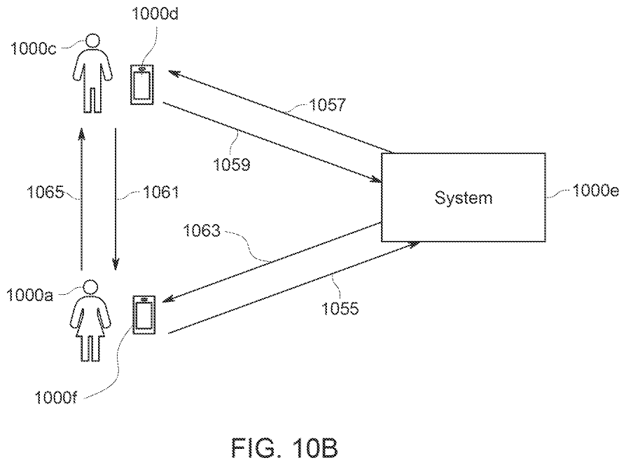

In this way, the system 900d allows each of the entities involved in the delegation process to request the encrypted delegation request data to verify the permissions allocated at a time of delegation. Further, the system 900d provided herein may not be limited to allowing the first user 900a (e.g. the owner) to allocate his/her second account (e.g. the relying party's account) to the second user 900e (e.g. a delegate) to perform the activity on-behalf of the first user 900a. For instance, the system 900d may also allow the first user 900a to delegate his/her identity account (e.g. the first account) associated with the system 900d to the second user 900e, which can be later used for an account restoration process when the first user 900a wants to replace his/her mobile device 900b or when the first user 900a misplaces his/her mobile device 900b. The account restoration process may include copying the user data (e.g. first account data) of the first user 900a from the mobile device 900b associated with the first user 900a to the mobile device 900f associated with the second user 900e and recovering the user data of the first user 900a from the mobile device 900f associated the second user 900e to a new mobile device associated with the first user 900a. Further, the account restoration process is as explained in the detailed description of FIGS. 10A-10B.

FIG. 10A illustrates an exemplary account storing message flow to copy, from a mobile device 1000b to a mobile device 1000d associated with a second user 1000c, the user data associated with a first user 1000a for account restoration, in accordance with one or more example embodiments. The account storing message flow comprises one or more entities, for instance, a first user 1000a, a mobile device 1000b associated with the first user 1000a, a second user 1000c, a mobile device 1000d associated with the second user 1000c, and a system 1000e. The first user 1000a corresponds to the user 101. The mobile device 1000b corresponds to the mobile device 103. The second user 1000c corresponds to the user 117. The mobile device 1000d corresponds to the mobile device 119. The system 1000e corresponds to the system 400. The system 1000e allows the first user 1000a to delegate the first account of the first user 1000a to the second user 1000c as explained in the detailed description of FIG. 6A. Once the first account of the first user 1000a is delegated to the second user 1000c, the account storing message flow starts at step 1001.

At step 1001, the mobile device 1000b authenticates the first user 1000a. For instance, the first user 1000a initiates the account restoration process by navigating to an account recover option in the system app and by selecting a virtual button (“delegate account recovery to another user”), and then the mobile device 1000b authenticates the first user 1000a as at least one of the valid first user and the invalid first user, as explained in the detailed description of FIG. 5B.

At step 1003, the mobile device 1000b transmits a restoration request to the system 1000e, if the first user 1000a is authenticated as the valid first user. For instance, the restoration request is transmitted from the first account of the first user 1000a to the system 1000d.

At step 1005, the system 1000e generates an ephemeral shared secret after receiving the restoration request. The generated ephemeral shared secret may be used in peer-to-peer verification over a local sharing connection. At step 1007, the system 1000e transmits an authentication request to the mobile device 1000d. For instance, the system 1000e transmits the authentication request to the fourth account (e.g. the identity account) of the second user 1000c. The authentication request comprises the restoration request that is indicative of the first user 1000a wishes to share the user data of the first user 1000a with the second user 1000c. Further, the authentication request comprises the ephemeral shared secret to use for the local sharing connection. At step 1009, the mobile device 1000d receive an approval on the restoration request and authenticates the second user 1000c using the fourth account of the second user 1000c. For instance, mobile device 1000d receives the approval and authenticates the second user 1000c as explained in the detailed description of FIG. 5B.

At step 1011, the mobile device 1000d transmits an authentication response to the system 1000e. The authentication response indicates the second user at least one of the valid second user and the invalid second user and further indicates the restoration request as a least one of an approved restoration request and an unapproved restoration request. At step 1013, the mobile device 1000d starts the local sharing connection with a unique identifier to be scanned by the mobile device 1000b, if the authentication response indicates the second user as the valid second user and the restoration request as the approved restoration request. The local sharing connection comprises a local network IP (Internet Protocol) connection over Wi-Fi, a local wireless connection over Bluetooth Low Energy (BLE), NFC, data encoded into QR code, and the like. In an example embodiment, the local wireless BLE connection is used for serving the local sharing connection.

Upon receiving the authentication response from the mobile device 1000d, the system 1000e records the authentication response. At step 1015, the system 1000e transmits, to the mobile device 1000b, a notification indicative of start peer restoration. The notification further comprises the ephemeral shared secret to use for the local sharing connection. At step 1017, the mobile device 1000b scans for the unique identifier of the mobile device 1000d. At step 1019 and at step 1021, the local BLE connection is established between the mobile device 1000b and the mobile device 1000d.

At step 1023, the mobile device 1000b and the mobile device 1000d generates a pair of ephemeral keys. At step 1025, the mobile device 1000b transmits an ephemeral key of the pair of the ephemeral keys to the mobile device 1000d. At step 1027, the mobile device 1000d transmits an ephemeral key of the pair of the ephemeral keys to the mobile device 1000b.

At step 1029, the mobile device 1000b and the mobile device 1000d generates a session encryption key using Elliptical Curve Diffie-Hellman (ECDH) to secure the local BLE connection between the mobile device 1000b and the mobile device 1000d such that eavesdropping from nearby radios is avoided. For instance, mobile device 1000b generates the session encryption key using the ECDH in conjunction with two ephemeral keys (one ephemeral key generated by the mobile device 1000b and another ephemeral key generated by the mobile device 1000d). Similarly, the mobile device 1000d may also generate the session encryption key. The generated session encryption key may be used to encrypt data, while exchanging the data between the mobile device 1000b and the mobile device 1000d.

At step 1031, the mobile device 1000d transmits, to the mobile device 1000b, a randomly generated byte sequence as a server challenge. At step 1033, the mobile device 1000b transmits, to the mobile device 1000d, a randomly generated byte sequence as a client challenge.

At step 1035, the mobile device 1000b computes a server response by hashing the client challenge and the ephemeral shared secret and further the mobile device 1000d transmits the computed server response to the mobile device 1000d. For instance, the server response may be mathematically represented as server response (SR)=SHA512 (client challenge (CC)+ephemeral shared secret (SS)).

At step 1037, the mobile device 1000d computes a client response by hashing the server challenge and the ephemeral shared secret and further the mobile device 1000d transmits the computed client response to the mobile device 1000b. For instance, the client response may be mathematically represented as client response (CR)=SHA512 (server challenge (SC)+ephemeral shared secret (SS)). Once, the client response is received by the mobile device 1000b, the mobile device 1000b checks if the mobile device 1000d has the ephemeral shared secret shared by the system 1000e using the client response. Similarly, the mobile device 1000d checks if the mobile device 1000b has the ephemeral shared secret shared by the system 1000e using the server response. To that end, the local BLE connection between the mobile device 1000b and the mobile device 1000d is verified.

At step 1039, the mobile device 1000b transmits the user data associated with the user 1000a to the mobile device 1000d. The user data includes the facial data of the user 1000a that is stored on the mobile device 1000b for authenticating the user 1000a. Additionally, the user data includes the behavioral data of the user 1000a.

In some embodiments, the user data is an encrypted format. To that end, at step 1041, the mobile device 1000b performs a lookup search for a secure encryption key in a secure enclave (e.g. Keychain in iOS and secure element in android). The secure encryption key may be used to encrypt/decrypt the user data. At step 1043, the mobile device 1000b transmits, to mobile device 1000d, the secure encryption key. At step 1045, the mobile device 1000d stores the received secure encryption key in the secure enclave of the mobile device 1000d. At step 1047 and at step 1049, both the mobile device 1000b and the mobile device 1000d serves the local BLE connection. At step 1051 and at step 1053, both the mobile devices 1000b and 1000d transmits, to the system 1000e, a restoration response indicating that the user data of the first user 1000a is copied to the mobile device 1000d.

In this way, the system 1000e allows to securely copy the user data associated with the first user 1000a on the mobile device 1000d associated with the second user 1000c for account restoration. Further, the system 1000e allows the first user 1000a to recover the user data associated with the firs user 1000a from the mobile device 1000d to a new mobile device associated with the first user 1000a, when the first user 1000a replaces the mobile device 1000b with the new mobile device or when the first user 1000a misplaces the mobile device 1000b.

FIG. 10B illustrates an exemplary scenario for recovering the user data associated with the first user 1000a from the mobile device 1000d to a mobile device 1000f associated with the first user 1000a, in accordance with one or more example embodiments. The mobile device 1000f may be the new mobile device brought by the first user 1000a as a replacement for the mobile device 1000b. At step 1055, the mobile device 1000f transmits a recovery request to the system 1000e. For instance, the first user 1000a initiates the account recovery by installing the system app and by selecting a virtual button (“restores account from another user”), and then the mobile device 1000f requests the first user 1000a to enter the email address associated with the first account of the first user 1000a, the mobile number associated with the first account of the first user 1000a and a mobile number associated with the fourth account of the second user 1000c. To that end, the recover request transmitted from the mobile device 1000f comprises the email address and the mobile number associated with the first user 1000a and the mobile number associated with the second user 1000c.

Upon receiving the recovery request, the system 1000e checks the first account of the first user 1000a and the fourth account of the second user 1000c. Further, the system 1000e generates the ephemeral shared secret. The generated ephemeral shared secret may be used in peer-to-peer verification over the local sharing connection between the mobile device 1000d and the mobile device 1000f.

At step 1057, the system 1000e transmits, to the first account of the first user 1000a and the fourth account of the second user 1000c, an authentication request for receiving the second user 1000c approval and for authenticating the second user 1000c. For instance, the system 1000e transmits the authentication request to the mobile device 1000d. The authentication request further comprises the ephemeral shared secret. Upon receiving the authentication request, the mobile device 1000d receive an approval from the second user 1000c and authenticates the second user 1000c as explained in the detailed description of FIG. 5B.

At step 1059, the mobile device 1000d transmits an authentication response to the system 1000e. The authentication response indicates the second user as at least one of the valid second user and the invalid second user. At step 1061, the mobile device 1000d starts the local sharing connection with a unique identifier to be scanned by the mobile device 1000f, if the authentication response indicates the second user as the valid second user. In one example embodiment, the local wireless BLE connection is used for serving the local sharing connection.

Upon receiving the authentication response from the mobile device 1000d, the system 1000e records the authentication response. At step 1063, the system 1000e transmits, to the mobile device 1000f, a notification indicative of start peer account recovery, if the authentication response indicates the second user as the valid second user. The notification further comprises the ephemeral shared secret to use for the local sharing connection.

At step 1065, the mobile device 1000f scans for the unique identifier of the mobile device 1000d, initiates the local sharing connection. To secure the local sharing connection, both the mobile devices 1000d and 1000f generates the ephemeral session encryption key as explained in the detailed description of FIG. 10A. Further, to ensure both the mobile devices 1000d and 1000f are intended mobile devices that are associated with the second user 1000c and the first user 1000a respectively, both the mobile device 1000d and 1000f executes the challenge and response sequence mechanisms as explained in the detailed description of FIG. 10A. This prevents an attacker from impersonating either side of the local sharing connection, who is trying to trick the system 1000e to reveal the sensitive information of the first user 1000a.

Once the local sharing connection is secured and verified, the mobile device 1000f sends the live-selfie video of the firs user 1000a to the mobile device 1000d. The mobile device 1000d authenticates the first user using the facial data of the first user stored on the mobile device 1000d.

Once the first user is authenticated as the valid first user, the mobile device 1000d transmits the user data associated with the first user 1000a and the secure encryption key over the local connection sharing. The mobile device 1000f securely stores the user data associated with the first user 1000a and the secure encryption key. Further, both the mobile device 1000d and the 1000f sends, to the system 1000e, a recover response indicative of successful completion of the account recover process.

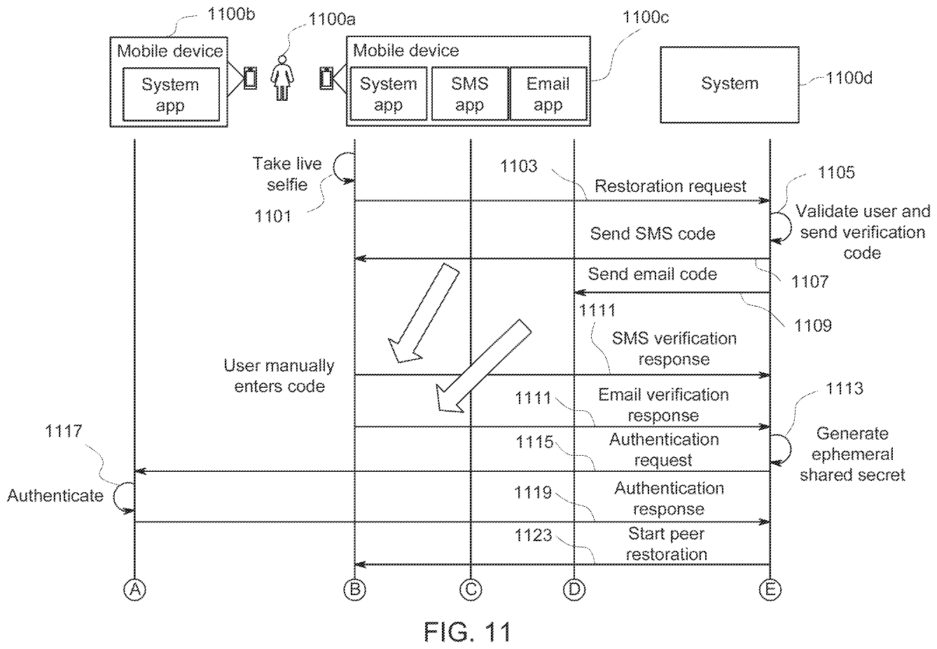

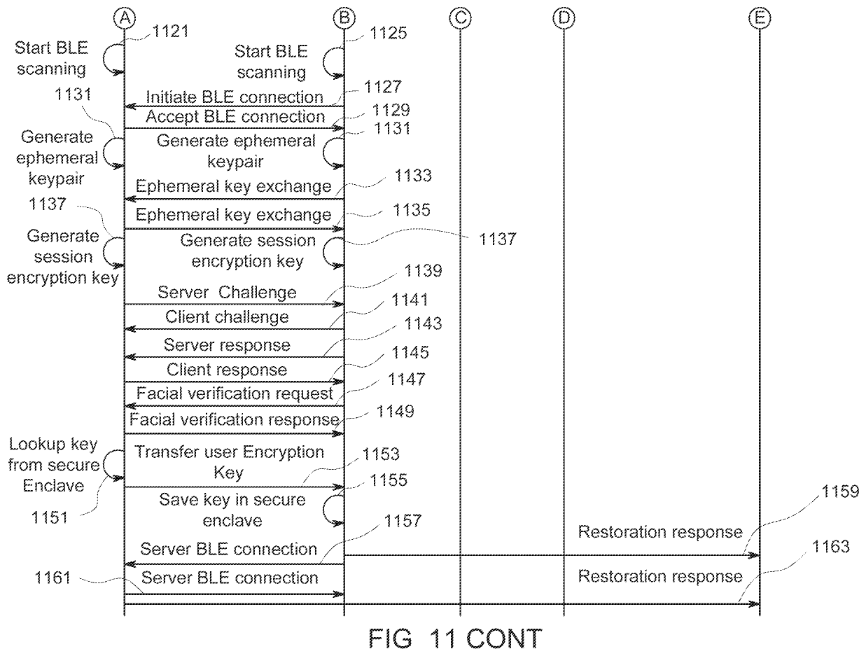

In this way, the system 1000e allows the first user 1000a to recover the user data of the first user 1000a from the mobile device 1000d associated with the second user 1000c, when the first user 1000a misplaces the mobile device 1000b associated with the first user 1000a. Further, the system 1000e provided herein may not limited to allowing the first user 1000a to delegate the first account of the first user 1000a to the second user 1000c. For instance, the system 1000e may also allow the first user 1000a to delegate the first account of the first user 1000a to his/her another mobile device as a process of account restoration. Further, the account restoration process is as explained in the detailed description of FIG. 11.

FIG. 11 illustrates an exemplary account restoring message flow for restoring, from a mobile device 1100b to a mobile device 1100c, the user data associated with a user 1100a, in accordance with one or more example embodiments. The account restoring message flow comprises one or more entities, for instance, the user 1100a, the mobile device 1100b, the mobile device 1100c, and a system 1100d. The user 1100a corresponds to the user 101. The mobile device 1100b corresponds to the mobile device 103. The mobile device 1100c may be a new mobile device owned by the user 1100a. The system 1100d corresponds to the system 400.

At step 1101, the mobile device 1100c acquires the live-selfie video of the user 1100a. For instance, the user 1100a initiates the account restoration by navigating to an account recover option in the system app and by selecting a virtual button (“recover from another device I own”), and then the mobile device 1100c acquires the live-selfie of the user 1100a. Additionally, the mobile device 1100c requests the use 1100a to provide the email address, and the mobile number associated with the first account (e.g. the identity account) of the user 1100a.

At step 1103, the mobile device 1100c transmits a restoration request to the system 1100d. The restoration request comprises the email address and the mobile number. At step 1105, the system 1100d checks the identity account of the user 1100a and generates a SMS code and an email code. At step 1107, the system 1100d sends the SMS code to a SMS app associated with the mobile device 1000c. At step 1109, the system 1100d sends the email code to an email app associated with the mobile device 1000c. At step 1111, the user 1100a is manually requested to enter the SMS code and the email code into the system app.

Once the SMS code and/or the email code are successfully verified, the system 1100d, at step 1113, generates the ephemeral shared secret. The generated ephemeral shared secret may be used in peer-to-peer verification over a local sharing connection. At step 1115, the system 1100d transmits an authentication request to the mobile device 1100b. For instance, the system 1100d transmits the authentication request to the first account of the user 1100a. The authentication request comprises the restoration request. Further, the authentication request comprises the ephemeral shared secret to use for the local sharing connection. At step 1117, the mobile device 1100b receive an approval on the restoration request and authenticates the user 1100a using the first account of the user 1100a. For instance, the mobile device 1100b receives the approval and authenticates the user 1100a as explained in the detailed description of FIG. 5B.

At step 1019, the mobile device 1100b transmits an authentication response to the system 1100d. The authentication response indicates the user at least one of the valid user and the invalid user and further indicates the restoration request as a least one of an approved restoration request and an unapproved restoration request. At step 1121, the mobile device 1100b starts the local sharing connection with a unique identifier to be scanned by the mobile device 1100c, if the authentication response indicates the user as the valid second user and the restoration request as the approved restoration request. The local sharing connection comprises a local network IP (Internet Protocol) connection over Wi-Fi, a local wireless connection over Bluetooth Low Energy (BLE), NFC, data encoded into QR code, and the like. In an example embodiment, the local wireless BLE connection is used for serving the local sharing connection.

Upon receiving the authentication response from the mobile device 1100b, the system 1100d records the authentication response. At step 1123, the system 1100d transmits, to the mobile device 1100c, a notification indicative of start peer restoration. The notification further comprises the ephemeral shared secret to use for the local sharing connection. At step 1125, the mobile device 1100c scans for the unique identifier of the mobile device 1100b. At step 1127 and at step 1129, the local BLE connection is established between the mobile device 1100b and the mobile device 1100c.

At step 1131, the mobile device 1100b and the mobile device 1100c generates a pair of ephemeral keys. At step 1133, the mobile device 1100c transmits an ephemeral key of the pair of the ephemeral keys to the mobile device 1100b. At step 1135, the mobile device 1100b transmits an ephemeral key of the pair of the ephemeral keys to the mobile device 1100c.

At step 1137, the mobile device 1100b and the mobile device 1100c generates a session encryption key using Elliptical Curve Diffie-Helman (ECDH) to secure the local BLE connection between the mobile device 1100b and the mobile device 1100c such that eavesdropping from nearby radios is avoided. For instance, mobile device 1100b generates the session encryption key using the ECDH in conjunction with two ephemeral keys (one ephemeral key generated by the mobile device 1100b and another ephemeral key generated by the mobile device 1100c). The generated session encryption key may be used to encrypt data, while exchanging the data between the mobile device 1100b and the mobile device 1100c.

At step 1139, the mobile device 1100b transmits, to the mobile device 1100c, a randomly generated byte sequence as a server challenge. At step 1141, the mobile device 1100c transmits, to the mobile device 1100b, a randomly generated byte sequence as a client challenge.

At step 1143, the mobile device 1100c computes a server response by hashing the client challenge and the ephemeral shared secret and further the mobile device 1100c transmits the computed server response to the mobile device 1100b. For instance, the server response may be mathematically represented as server response (SR)=SHA512 (client challenge (CC)+ephemeral shared secret (SS)).

At step 1145, the mobile device 1100b computes a client response by hashing the server challenge and the ephemeral shared secret and further the mobile device 1100b transmits the computed client response to the mobile device 1100c. For instance, the client response may be mathematically represented as client response (CR)=SHA512 (server challenge (SC)+ephemeral shared secret (SS)). Once, the client response is received by the mobile device 1100c, the mobile device 1100c checks if the mobile device 1100b has the ephemeral shared secret shared by the system 1100d using the client response. Similarly, the mobile device 1100b checks if the mobile device 1100c has the ephemeral shared secret shared by the system 1100d using the server response. To that end, the local BLE connection between the mobile device 1100b and the mobile device 1100c is verified.

At step 1147, the mobile device 1100c transmits a facial verification request comprising the live-selfie video (e.g. 2D or 3D facial landmarks) of the user 1100a to the mobile device 1100b. At step 1149, the mobile device 1100b compares the live-selfie video of the user 1100a with the facial data stored on the mobile device 1100b and authenticates the user 1100a as the valid user. Further, at step 1149, the mobile device 1100b transmits a facial verification response to the mobile device 1100c. At step 1151, the mobile device 1100b performs a lookup search for the secure encryption key in the secure enclave (e.g. Keychain in iOS and secure element in android). At step 1153, the mobile device 1100b transmits the user data of the user 1000a along with the secure encryption key to the mobile device 1100c. At step 1155, the mobile device 1100c securely stores the user data of the user 1100a. Further, at step 1155, the mobile device 1100c securely stores the secure encryption key in the secure enclave of the mobile device 1100c. At step 1157, the mobile device 1100c serves the BLE connection. At step 1159, the mobile device 1100c transmits a restoration response to the system 1100d. At step 1161, the mobile device 1100b serves the BLE connection. At step 1163, the mobile device 1100b transmits the restoration response to the system 1100d. The restoration response indicates the successful completion of the account restoration process.

In this way, the system 1100d allows the user 1100a to securely restore the user data associated with the user 1100a from the mobile device 1100b (e.g. an existing device) to the mobile device 1100c (e.g. a new device). Once, the user data is stored on the mobile device 1100c, the system 1100d allows the user 1100a to prove, using the mobile device 1100c, the authenticity of the user 1000a in other relying party applications and/or to delegate, using the mobile device 1100c, his/her relying party account to their relying partner as explained in the detailed description of FIGS. 5-9.

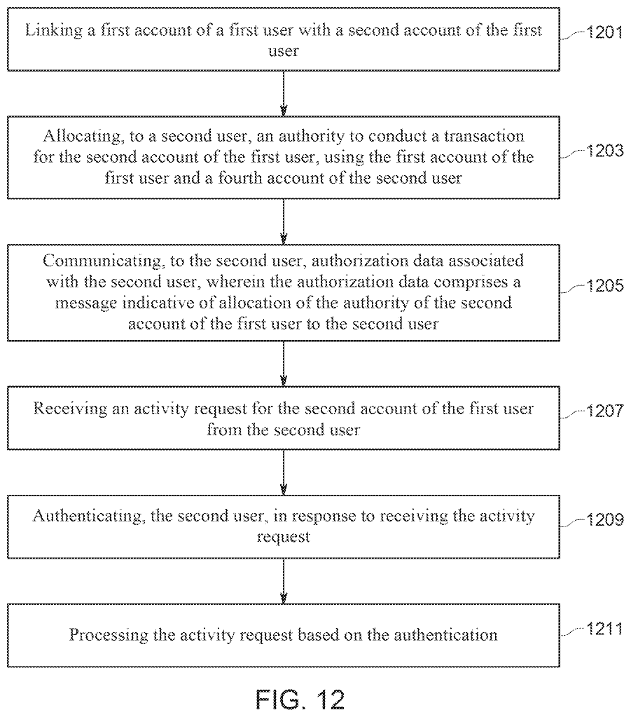

FIG. 12 illustrates a delegation method executed by the system 400 for allowing the first user to allocate his/her second account to the second user to perform the activity on-behalf of the first user, in accordance with one or more example embodiments. Starting at step 1201, the delegation method includes linking the first account of the first user with the second account of the first user. For instance, the account linking module 401a of the system 400 may be configured to link the first account of the first user (e.g. the user 101) with the second account of the first user as explained in the detailed description of FIG. 5B.

At step 1203, the delegation method includes allocating, to the second user, the authority to conduct the transaction for the second account of the first user, using the first account of the first user and the fourth account of the second user. For instance, the delegation module 401b of the system 400 may be configured to allocate, to the second user (e.g. the user 117) the authority to conduct the transaction for the second account of the first user, using the first account of the first user and the fourth account of the second user, as explained in the detailed description of FIG. 6A.

At step 1205, the delegation method includes communicating, to the second user, the authorization data associated with the second user. The authorization data comprises the message indicative of allocation of the authority of the second account of the first user to the second user. For instance, the activity processing module 401c of the system 400 may be configured to communicate, to the second user, the authorization data associated with the second user as explained in the detailed description of FIG. 7B.

At step 1207, the delegation method includes receiving the activity request for the second account of the first user from the second user. For instance, the activity processing module 401c of the system 400 may be configured to receive the activity request for the second account of the first user from the second user via the relying party application database.

At step 1209, the delegation method includes authenticating, the second user, in response to receiving the activity request. For instance, the activity processing module 401c of the system 400 may be configured to authenticate the second user based on the activity request as explained in the detailed description of FIG. 7B.

At step 1211, the delegation method includes processing the activity request based on the authentication. For instance, the activity processing module 401c of the system 400 may be configured to process the activity request based on the authentication as explained in the detailed description of FIG. 7B.

On implementing the delegation method using the system 400, the system 400 may be configured to allow the first user to allocate his/her second account to the second user and further process the activity request, when the second user tires to perform the activity on-behalf of the first user.

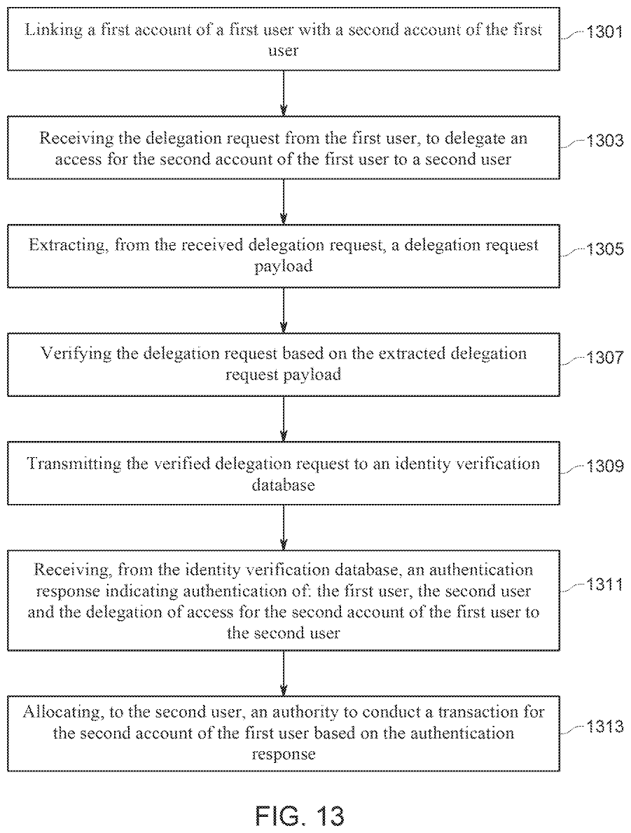

FIG. 13 illustrates a delegation request managing method executed by the relying party application database 121 for managing the delegation request, in accordance with one or more example embodiments. Starting at step 1301, the delegation request managing method includes linking the first account of the first user with the second account of the first user. For instance, the relying party application database 121 may link the first account of the first user (e.g. the user 101) with the second account of the first user as explained in the detailed description of FIG. 4A.

At step 1303, the delegation request managing method includes receiving the delegation request from the first user, to delegate an access for the second account of the first user to the second user. For instance, the relying party application database 121 receives the delegation request from the first user, to delegate an access for the second account of the first user to the second user as explained in the detailed description of FIG. 6A.

At step 1305, the delegation request managing method includes extracting, from the received delegation request, the delegation request payload. For instance, the relying party application database 121 extracts, from the received delegation request, the delegation request payload. The delegation request payload (e.g. the delegation request payload 601a) comprises the data associated with at least the second account of the first user, the third account of the second user (e.g. the user 117), the authorization data indicative of allocation of authority for accessing the second account of the first user to the second user, or a combination thereof.

At step 1307, the delegation request managing method includes verifying the delegation request based on the extracted delegation request payload. For instance, the relying party application database 121 verifies the delegation request based on the extracted delegation request payload as explained in the detailed description of FIG. 6A.

At step 1309, the delegation request managing method includes transmitting the verified delegation request to the identity verification database. For instance, the relying party application database 121 transmitting the verified delegation request to the system 400.

At step 1311, the delegation request managing method includes receiving, from the identity verification database, the authentication response indicating authentication of: the first user, the second user and the delegation of access for the second account of the first user to the second user. For instance, the relying party application database 121 receiving, from the system 400, the authentication response.

At step 1313, the delegation request managing method includes allocating, to the second user, the authority to conduct the transaction for the second account of the first user based on the authentication response. For instance, the relying party application database 121 allocates, to the second user, the authority to conduct the transaction for the second account of the first user based on the authentication response as explained in the detailed description of FIG. 6A.

On implementing the delegation request managing method using the relaying party application database 121, the relying party application database 121 may allocate, to the second user, the authority to conduct the transaction for the second account of the first user. Further, the system provided herein may be used in various applications, for instance, a mobile service provider application, a customer service application, an age-restricted product purchase application, a viral disease verification application, a voter registration application, and the like.

1. Mobile Service Provider Application.

When a user wants to make changes to their mobile service provider account (e.g. adding or removing a line, changing their rate plan, inquire about billing, or the like), the user needs to travel to a physical store or call-up a customer support. Upon reaching the customer support, the user needs to verify their identity. To that end, currently available methods requests the user to provide a shared secret like a four-digit PIN code or answering one or more security questions. Once authenticated, the user is allowed to make changes to their mobile service provider account. For instance, the user is allowed to change a mobile number of the user. In some cases, this may result in sim-jacking, due to weak identity verifications like requesting for the four-digit PIN code or answering one or more security questions. As used herein, the sim-jacking may refer to fraudulent activities performed by an attacker to swap a current mobile number of a user to a new mobile number.

Sim-jacking is particularly problematic, as SMS OTP (One Time Password) is commonly used as a means for verifying identity when the user clicks “Forgot My Password” link in several websites and/or mobile applications. If an attacker gets control of a user's mobile number, then the attacker may be able to request password reset verification codes for one or more accounts of the users and further the attacker might take control over the one or more accounts of the user.

To address this vulnerability, the system is provided herein for authenticating the user that eliminates a possibility of the attacker posing as the user. For instance, when the user contacts the mobile service provider by calling-up customer support and requests for a new mobile number to replace an existing mobile number, the customer support agent requests the user to provide a name of the user, the existing mobile number of the user and the like. Upon obtaining the name of the user and the existing mobile number, the customer support agent identifies the account of the user associated with the mobile service provider. The customer support agent sends a request to the disclosed system to verify authenticity of the user. Upon receiving the request, the disclosed system transmits, to the mobile device associated with the user, the authentication request for authenticating the user. The mobile device receives the approval from the user and authenticates the user as explained in the detailed description of FIG. 5B. The disclosed system receives the authentication response from the mobile device associated with the user and records the authentication response as a result of authentication. The authentication response indicates the user as at least one of the valid user or invalid user. If the authentication response indicates the user as the valid user, the disclosed system sends, to the customer support agent, a response to provide the new mobile number as a replacement of the existing mobile number. In this way, the disclosed system addresses the vulnerabilities in the mobile service provider application by authenticating the user that eliminates a possibility of the attacker posing as the user.

2. Customer Service Application.

In addition to the mobile service provider, most customer support call centers also use similar identity verification for verifying the identity of the user, prior to servicing a request from the user. For instance, a customer support agent requests the user to provide the shared secret like the four-digit PIN code or to answer one or more security questions, prior to servicing the request from the user. In some cases, customer support agents of business entities may initiate a call to the user for informing the user about past due bills or other collection processes. In these cases, the customer support agents ask for user verification, typically without providing any of their own in return. Attackers easily exploit this condition to extract sensitive personal information from the user, who is under the assumption that the customer support agent is truthfully a representative of a stated business entity.

To avoid the possible vulnerabilities from both the ends of the call, the system provided herein authenticates both the user and the customer support agent. As used herein, the customer service application may not be limited to phone calls, but also includes any communication medium comprising text messaging, chat interface over web browser, voice, video messaging, and the like. As used herein, the customer support agent may not be limited to a human being, but may also include chat bots (text, voice, or video), and the like.

For example, when the user reaches out to a business entity (e.g. bank) to inquire about an account balance, the customer support agent (e.g. a person or a bot) of the business entity responds and requests for the user authentication before proceeding. The customer support agent initiates identity verification of the user by making an API call to the disclosed system. The disclosed system logs the interaction and forwards, to the mobile device associated with the user, the authentication request for authenticating the user. The authentication request includes a message indicative of the business entity that the user reached to check the account balance is requesting the user's identity verification. The mobile device receives the approval and authenticates the user as explained in the detailed description of FIG. 5B. The disclosed system receives the authentication response from the mobile device associated with the user and records the authentication response as a result of authentication. The authentication response indicates the user as at least one of the valid user or invalid user. If the authentication response indicates the user as the valid user, the disclosed system sends, to the customer support agent, a response for allowing the user to view the account balance. Additionally, in some cases, when the customer support agent initiates the communication, the disclosed system may authenticate the customer support agent before establishing the communication and further the disclosed system allows the customer support agent to forward, to the user, a notification indicating about the business entity and imminent call timing before establishing the communication. Additionally, the notification may further include an expected mobile number from which the customer support agent would contact the user. In this way, the disclosed system authenticates both the user and the customer support agent to avoid the possible vulnerabilities from both the ends.

3. Age-Restricted Product Purchase Application.

Generally, in the age-restricted product purchase applications such as purchase of alcohol, tobacco products, and the like, the user is requested to provide a government identity card associated with the user to prove that age of the user is above certain age limit. As a result, personal information associated with the government identity card is exposed to a third party, who only needs the specific age of the user. As used herein, the government identity card may include a driving license of the user, a passport of the user, and the like.

To that end, the disclosed system authenticates the user and further the disclosed system is configured to compare the age of the user with a threshold age limit after successfully authenticating the user, to allow the transaction. In this way, the disclosed system verifies the identity of the user along with the age of the user, while also preserving privacy of the user.

4. Viral Disease Verification Application.

Given the recent pandemic, there may be a need for verification/proof of COVID-19 antibodies as a condition of admittance back to work or even public places/events. In this case, the disclosed system plays an important role for providing verifiable status of testing result, while preserving the privacy of the user (e.g. a patient or a presenter) by limiting the information presented to verify the status of the user to minimum required information.

For example, in near future, it may be required to prove antibody testing status to gain entry into public events such as sporting events, or the like. The verification may be as follows: when the user tests positive for COVID-19 antibodies, this result, is certified by the testing lab (e.g. Quest Diagnostic®), is encrypted and signed by the testing lab and forwarded to the user via the disclosed system. For instance, the disclosed system receives the encrypted message and forwards the encrypted message to the tested user, who then reviews the result and accepts the result upon signature verification of the testing lab. Further, the result may be stored locally in an encrypted filesystem of the mobile device associated with the tested user.

When the tested user goes to the sport event, for instance, a baseball stadium that requires proof of antibodies, the user may need to scan a QR code via the system app before entering the baseball stadium. This may trigger the identity verification of the user by requesting an access to the user's lab test result. Upon verification, the lab result is decrypted and a badge (e.g. a message) or a QR code is displayed on the mobile device associated with the user that to be shown to an attendant of the baseball stadium. In this way, the disclosed system provides only the required information (e.g. the bandage indicating the user's test status), while protecting the personal information such as the name of the user, age of the user, and address of the user and the like.

5. Voter Registration Application.

Generally, a voting process includes at least three steps, for instance, identity verification of the user (e.g. a voter), verification of the user's voter registration status, and accounting of the user participation in voting process. Currently, these three steps are manually performed, when the user enters a polling place. For instance, the identity verification is done by manually comparing the user's face with the user's face in the government identity card (e.g. voter identity card) of the user; the verification of the user's voter registration status is done by manually matching the name and the address of the user to a line in a printed list of names; and the accounting of the user participation in voting process is done by manually marking an entry of the user in the printed list of names.

To this end, it is objective of some embodiments of the disclosed system to avoid manual errors and fraudulent activities in the voting process by replacing the manual steps of the voting process as follows: when the user registers to vote with their State, State office processes a request. The disclosed system allows the State office to send an encrypted data signed by the State office to the user. Upon receiving the encrypted data signed by the State office from the State office, the disclosed system sends, to the mobile device associated with the user, the authentication request comprising the encrypted data signed by the State office. The mobile device receives the approval from the user on the request and authenticates the user as explained in the detailed description of FIG. 5A. The disclosed system receives the authentication response from the mobile device associated with the user and records the authentication response as a result of authentication. Additionally, the disclosed system stores the encrypted data signed by the State office as a record such that the user and the State office can decrypt and reference the encrypted data signed by the State office at any time.

When the user arrivers at the polling place for casting vote, the user needs to scan a QR code, which prompts for authenticating the user as explained in the detailed description of FIG. 5B. Upon successful verifications, the system app displays a QR code that represents required information of the confirmed voter to be scanned by a volunteer at the polling place, to be inputted into their system. Alternatively, the disclosed system may submit a confirmation status directly to the State voting backend server via the API call, which may automatically mark the user as present, and a simple “Cleared to proceed” bandage may be displayed to allow the user for casting vote. In this way, the disclosed system replaces the manual steps of the voting process with an automated identity verification process and avoids manual errors and fraudulent activities in the voting process.

6. Power of Attorney.

Power of attorney is a case where the user (e.g. a principal user) authorizes a delegate user to act on-behalf of the principal user. Typically, power of attorney documents go into effect when the principal user becomes incapacitated in some way, or otherwise unable to make their own decisions regarding matter of financial, health care, etc. The power of attorney documents allow the delegate user to take decisions on-behalf of the principal user. Current requirements for a legally binding power of attorney relationship are: creation of a power of attorney document, signed by the principal user, and multiple copies notarized and certified by a registered public notary. Another “soft” requirement (soft in that it's a subjective assessment) is that the principal user is of sound mind when they enter the agreement. This assessment can be performed by the notary, but a written note from a doctor can also be used to prove metal fitness.

Therefore, the power of attorney process involves multiple parties for few verifications to be performed. As is also evident, is the prevalence and reliance on a physical signature from multiple parties in addition to seal or stamp from the notary. All of which are currently sufficient mechanism of proof of identity. In order to improve the speed of the power of attorney process and improve overall user experience associated with the power of attorney process, the disclosed system allows the user to invoke the power of attorney relationships using the delegation process provided herein, while also including the public notary.

For instance, the disclosed system allows the principal user to generate the power attorney document and to upload the power attorney document by currently available means. The power of attorney document may be descriptive and verbose set of permissions that are being delegated from the principal user to the delegate user. Further, the system allows the principal user to authorize the delegate user to take decisions on-behalf of the principal user using the delegation process provided herein. To this end, the power of attorney document may be shared between multiple parties (involved in the power of attorney process) and stored locally as a representation of the power of attorney document with multiple digital signatures. In this case, the relying party may be the public notary.

When the principal user goes incapacitated, then the delegate user is allowed to present the power of attorney document with multiple digital signatures to relevant parties (e.g. financial institution, country clerk, hospital administration, and the like) to take decisions on-behalf of the principal user. In this way, the disclosed system may be used for invoking the power of attorney relationships to improve the speed of the power of attorney process and overall user experience associated with the power of attorney process.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A computer-implemented method for managing a delegation request, the computer-implemented method comprising:
linking a first account of a first user with a second account of the first user and storing, in a relying party application database, an account linking information;
receiving the delegation request from the first user, to delegate an access for the second account of the first user to a second user;
extracting, from the received delegation request, a delegation request payload, wherein the delegation request payload comprises data associated with at least the second account of the first user, a third account of the second user, authorization data indicative of allocation of authority for accessing the second account of the first user to the second user, or a combination thereof;
verifying the delegation request based on the extracted delegation request payload;
transmitting the verified delegation request to an identity verification database;
receiving, from the identity verification database, an authentication response indicating authentication of the first user, the second user and the delegation of access for the second account of the first user to the second user; and
allocating, to the second user, an authority to conduct a transaction for the second account of the first user based on the authentication response.

2. The method of claim 1, wherein the first account of the first user is associated with the identity verification database.

3. The method of claim 1, further comprising receiving the account linking information from the identity verification database.

4. The method of claim 1, further comprising:
generating encrypted delegation request data for the verified delegation request; and
transmitting the encrypted delegation request data to the identity verification database.

5. The method of claim 1, wherein the second account of the first user and the third account of the second user are both associated with the relying party application database.

6. The method of claim 1, wherein verifying the delegation request based on the extracted delegation request payload further comprises:
verifying ownership data associated with the second account of the first user; and
verifying identity data associated with each of the third account of the second user and the first account of the first user,
wherein the verification is performed based on data stored in the relying party database.

7. The method of claim 1, wherein the authentication response received from the identity verification database comprises:
first authentication data indicating authentication of identity of the first user;
second authentication data indicating authentication of identity of the second user; and
confirmation data indicating confirmation of delegation of authority, to the second user, for accessing the second account of the first user.

8. The method of claim 7, wherein the first authentication data indicating authentication of identity of the first user comprises verification data for verification of at least a first live-selfie video of the first user to authenticate the identity of the first user.

9. The method of claim 7, wherein the second authentication data indicating authentication of identity of the second user comprises verification data for verification of at least a second live-selfie video of the second user to authenticate the identity of the second user.

10. The method of claim 1, wherein linking the first account of the first user with the second account of the first user further comprises:
receiving, from the second account of the first user, an account link request;
identifying the first account of the first user, in response to receiving the account link request;
authenticating the first user using the first account of the first user, wherein authenticating the first user further comprises:
transmitting an account linking authentication request to the first account of the first user, wherein the account linking authentication request comprises a message indicative of the account link request; and
receiving an account linking authentication response from the first account of the first user, in response to transmitting the account linking authentication request, wherein the account linking authentication response indicates the first user as at least one of a valid first user and an invalid first user and further the account linking authentication response indicates the account link request as at least one of an approved account link request and an unapproved account link request; and
linking the first account of the first user with the second account of the first user, in response to receiving the account linking authentication response indicating the first user as the valid first user and the account link request as the approved account link request.

11. The method of claim 1, further comprising:
receiving an activity request, from the third account of the second user, to perform the transaction for the second account of the first user;
transmitting the activity request to the identity verification database for authenticating the identity of the second user and the authority of the second user to conduct the transaction;
receiving an activity confirmation response from the identity verification database indicating authentication of the identity of the second user and the authority of the second user to conduct the transaction; and
conducting the transaction for the second account of the first user based on the received activity confirmation response.

12. The method of claim 11, wherein the activity confirmation response comprises data indicating authentication of identity of the second user and a confirmation by the second user for performing the transaction, wherein the data further comprises verification data for verification of at least a third live-selfie video of the second user to authenticate the identity of the second user.

13. The method of claim 1, further comprising:
receiving a revocation request from the first account of the first user; and
revoking, from the second user, the authority to conduct the transaction for the second account of the first user, in response to receiving the revocation request from the first account of the first user.

14. A system comprising:
a memory configured to store computer-executable instructions; and
at least one processor configured to execute the computer-executable instructions to:
link a first account of a first user with a second account of the first user;
allocate, to a second user, an authority to conduct a transaction for the second account of the first user, using the first account of the first user and a fourth account of the second user;
communicate, to the second user, authorization data associated with the second user, wherein the authorization data comprises a message indicative of allocation of the authority of the second account of the first user to the second user;
receive an activity request for the second account of the first user from the second user;
authenticate, the second user, in response to receiving the activity request; and
process the activity request based on the authentication.

15. The system of claim 14, wherein to authenticate the second user, in response to receiving the activity request, the processor is further configured to:
transmit, to a fourth account of the second user, an activity authentication request for acquiring an approval on the activity request from the second user and for acquiring at least a live-selfie video of the second user, wherein the activity authentication request comprises a message indicative of the activity request; and
receive, from the fourth account of the second user, an activity authentication response, in response to transmitting the activity authentication request, wherein the activity authentication response indicates the second user as a valid second user if the live-selfie video of the second user matches with facial data of the second user stored on the fourth account of the second user and further the activity authentication response indicates the activity request as an approved activity request if the second user approves the activity request in the fourth account of the second user.

16. The system of claim 14, wherein to allocate, to the second user, the authority of the second account of the first user, the processor is further configured to:
receive first encrypted data associated with the first account of the first user, second encrypted data associated with the fourth account of the second user and third encrypted data associated with the second account of the first user, wherein the first encrypted data, the second encrypted data and the third encrypted data are generated in response to receiving a delegation request from the second account of the first user, wherein each of the first encrypted data, the second encrypted data and the third encrypted data comprises an encrypted message indicative of allocating the authority of the second account of the first user to the second user;
authenticate, using the first account of the first user, the first user based on the first encrypted data, wherein to authenticate the first user, the processor is further configured to:
transmit a first authentication request to the first account of the first user, wherein the first authentication request comprises the first encrypted data; and
receive a first authentication response from the first account of the first user, in response to transmitting the first authentication request, wherein the first authentication response indicates the first user as at least one of a valid first user and an invalid first user and further the first authentication response indicates the delegation request as at least one of a first approved delegation request and a first unapproved delegation request;
authenticate, using the fourth account of the second user, the second user based on the second encrypted data, in response to receiving the first authentication response indicating the first user as the valid first user and the delegation request as the first approved delegation request, wherein to authenticate the second user, the processor is further configured to:
transmit a second authentication request to the fourth account of the second user, wherein the second authentication request comprises the second encrypted data; and
receive a second authentication response from the fourth account of the second user, in response to transmitting the second authentication request, wherein the second authentication response indicates the second user as at least one of a valid second user and an invalid second user and further the second authentication response indicates the delegation request as at least one of a second approved delegation request and a second unapproved delegation request; and
allocate the authority of the second account to the second user, in response to receiving the second authentication response indicating the second user as the valid second user and the delegation request as the second approved delegation request.

17. The system of claim 14, wherein to communicate, to the second user, the authorization data associated with the second user, the processor is further configured to:
receive an authorization payload request from the third account of the second user, wherein the authorization payload request is received in response to receiving, from the second user, a login request to the third account of the second user;
authenticate the second user using the fourth account of the second user, in response to receiving the authorization payload request, wherein authenticating the second user further comprises:
transmit a login authentication request to the fourth account of the second user; and
receive a login authentication response from the fourth account of the second user, in response to transmitting the login authentication request, wherein the login authentication response indicates the second user as at least one of a valid second user and an invalid second user;
perform a lookup search for identifying the third encrypted data, in response to receiving the login authentication response indicating the second user as the valid second user; and
transmit, to the third account of the second user, the third encrypted data as an authorization payload response for communicating the authorization data associated with the second user.

18. The system of claim 14, wherein to link the first account of the first user with the second account of the first user, the processor is further configured to:
receive, from the second account of the first user, an account link request;
identify the first account of the first user, in response to receiving the account link request;
authenticate the first user using the first account of the first user, wherein to authenticate the first user, the processor is further configured to:
transmit an account linking authentication request to the first account of the first user, wherein the account linking authentication request comprises a message indicative of the account link request; and
receive an account linking authentication response from the first account of the first user, in response to transmitting the account linking authentication request, wherein the account linking authentication response indicates the first user as at least one of a valid first user and an invalid first user and further the account linking authentication response indicates the account link request as at least one of an approved account link request and an unapproved account link request; and
link the first account of the first user with the second account of the first user, in response to receiving the account linking authentication response indicating the first user as the valid first user and the account link request as the approved account link request.

19. A computer program product comprising a non-transitory computer readable medium having stored thereon computer executable instruction which when executed by at least one processor, cause the processor to carry out operations for managing a delegation request, the operations comprising:
linking a first account of a first user with a second account of the first user and storing, in a relying party application database, an account linking information;
receiving the delegation request from the first user, to delegate an access for the second account of the first user to a second user;
extracting, from the received delegation request, a delegation request payload, wherein the delegation request payload comprises data associated with at least the second account of the first user, a third account of the second user, authorization data indicative of allocation of authority for accessing the second account of the first user to the second user, or a combination thereof;
verifying the delegation request based on the extracted delegation request payload;
transmitting the verified delegation request to an identity verification database;
receiving, from the identity verification database, an authentication response indicating authentication of the first user, the second user and the delegation of access for the second account of the first user to the second user; and
allocating, to the second user, an authority to conduct a transaction for the second account of the first user based on the authentication response.

20. The computer program product of claim 19, wherein the first account of the first user is associated with the identity verification database.
